(19) United States
(12) Patent Application Publication
(10) Pub. No.: US 2026/0061617 A1
(43) Pub. Date: Mar. 5, 2026

(54) SYSTEMS, APPARATUSES, AND METHODS FOR AUTOMATED ELEVATOR NAVIGATION OF A ROBOTIC DEVICE

(71) Applicant: Diligent Robotics, Inc., Austin, TX (US)

(72) Inventors: Reymundo Alejandro GUTIERREZ, Round Rock, TX (US); Ruotong JIA, Austin, TX (US); Anjana NELLITHIMARU, Bryan, TX (US); Amr Khalil MOUSSA, Chapel Hill, NC (US); Andrew Paul BURT STOUT, Cambridge, MA (US); Peter WORSNOP, Bethesda, MD (US); Jonathan Walker MEYER, Austin, TX (US); Adam David ALLEVATO, Austin, TX (US); Laura STELZNER, Redwood City, CA (US); Harjatin Singh BAWEJA, Austin, TX (US); Stone Xavier TEJEDA, Austin, TX (US); Vivian Yaw-Wen CHU, Austin, TX (US); Andrea Lockerd THOMAZ, Austin, TX (US)

(73) Assignee: Diligent Robotics, Inc., Austin, TX (US)

(21) Appl. No.: 19/384,901

(22) Filed: Nov. 10, 2025

Related U.S. Application Data
(63) Continuation of application No. PCT/US2024/029132, filed on May 13, 2024.
(60) Provisional application No. 63/465,779, filed on May 11, 2023.
(60) Provisional application No. 63/465,791, filed on May 11, 2023.

(51) Int. Cl. B25J 9/16

(52) U.S. Cl. CPC B25J 9/1679; B25J 9/1605; B25J 9/1612; B25J 9/162; B25J 9/1664; B25J 9/1697

(57) ABSTRACT

Systems, apparatus, and methods are described for robotic learning, planning, and execution of skills, including navigation using elevators. In one or more embodiments, a robotic device may need to autonomously take an elevator, e.g., by using its autonomy features and/or relating on application programming interfaces (APIs) to communicate with elevators.

### CROSS-REFERENCE TO RELATED APPLICATIONS

This application is a continuation of International Patent Application No. PCT/US2024/029132, filed May 13, 2024, which claims priority to, and the benefit of, U.S. Application No. 63/465,779, filed on May 11, 2023; and U.S. Application No. 63/465,791, filed May 11, 2023, the entire contents of which are incorporated herein by reference.

### TECHNICAL FIELD

The present disclosure generally relates to the field of robotic learning, planning, and execution of skills. In particular, the present disclosure is related to methods and apparatuses for automated elevator navigation of a robotic device.

### BACKGROUND

Robots can be used to perform and automate a variety of tasks. Robots can perform tasks by moving through an environment, such as an office building or a hospital. Robots can be equipped with wheels, tracks, or other mobile components that enable them to move autonomously around an environment. Some robots are trained to move through a single plane in an environment. Additionally, some robots do not have the capability to move through stairs to access different floors of multiple story buildings. Some robots are limited in their ability to manipulate elevator systems, interpret varying altitude, interact with elevator systems, or maneuver around obstacles in elevator systems, to arrive at a destination located at a different floor from a starting position of the robots.

Moreover, most commercial robots are designed to operate in structured environments, e.g., a factory, a warehouse, etc. Unstructured environments, e.g., environments involving humans, such as hospitals and homes, can impose additional challenges for programming a robot. In unstructured environments, robots cannot rely on complete knowledge of their surrounding environment but must be able to perceive changes in their surrounding environment and adapt based on those changes. Thus, in unstructured environments, robots have to continuously or repeatedly acquire information about the environment to be able to make autonomous decisions and perform tasks. Oftentimes, the movements of a robot, e.g., the movements of an arm or end effector in the environment, are also constrained by objects and other obstacles in the environment, further adding to the challenge of robot perception and manipulation. Given the uncertain and dynamic nature of unstructured environments, robots typically cannot be pre-programmed to perform tasks.

Accordingly, there is a need for robotic systems that can perceive and adapt to dynamic and unstructured environments, and can perform sophisticated tasks within those environments, without relying on pre-programmed manipulation skills.

### SUMMARY

Systems, apparatus, and methods are described for robotic learning, planning, and execution of skills, including navigation using elevators. In one or more embodiments, a robotic device may need to autonomously take an elevator, e.g., by using its autonomy features and/or relating on application programming interfaces (APIs) to communicate with elevators. In some embodiments, a robotic device can navigate using an elevator by implementing one or more of: elevator lobby management, elevator call button manipulation, elevator entry, ride management, floor button manipulation, floor detection, and elevator exit. In some embodiments, a robotic device can implement intent or current state via social cues. In some embodiments, a robotic device can implement data recording, e.g., for additional training and/or planning and/or to report information to one or more users.

In some embodiments, an apparatus comprises a memory; a processor operatively coupled to the memory and configured to execute instructions stored in the memory to: retrieve information of an elevator car, the information including a floorplan of the elevator car and a configuration of an elevator button interface in the elevator car; determine, for each value of a first parameter from a plurality of parameters, a likelihood of successfully pressing a target button across a range of values of one or more second parameters from the plurality of parameters other than the first parameter by simulating, over a plurality of trials, pressing the target button at that value of the first parameter and across the range of values of the one or more second parameters, the plurality of parameters including a location of the target button, a position of a robotic device, and a pose of a manipulating element of the robotic device; generate, for each value of the first parameter, a reachability map indicative of the likelihood of successfully pressing the target button across the range of values of the one or more second parameters based on outcomes of simulating the pressing over the plurality of trials; and store the reachability map for each value of the first parameter in the memory.

In some embodiments, an apparatus, comprises a manipulating element including a plurality of joints and segments, the manipulating element configured to be positioned in a plurality of poses for initiating a trajectory for pressing one or more target buttons; a transport element configured to move along a surface; one or more sensors; and a processor operatively coupled to the manipulating element, the transport element, and the one or more sensors, the processor configured to: determine a location of a target button in an elevator car; determine which pose from the plurality of poses the manipulating element is positioned in; select, using a reachability map associated with the pose, a position of the transport element likely to be successful at pressing the target button given the location of the target button; and navigate, following a path, to the position of the transport element.

In some embodiments, an apparatus, comprises a manipulating element including a plurality of joints and segments; a transport element configured to move along a surface; one or more sensors; and a processor operatively coupled to the manipulating element, the transport element, and the one or more sensors, the processor configured to: determine a position of a target button in an elevator car; compare the position of the target button to a plurality of predefined positions of the target button; in response to determining, based on the comparing, that the position of the target button does not match any one of the plurality of predefined positions, identify a set of predefined positions from the plurality of predefined positions that are closest to the position of the target button; determine, based on a set of reachability maps indicative of a likelihood of pressing the target button at the set of predefined positions and across a range of predefined positions of the transport element, a reachability map indicative of a likelihood of pressing the target button at the position of the target button and across the range of predefined positions of the transport element.

In some embodiments, A method comprises calling, at a robotic device, at least one elevator car to arrive in an elevator lobby; navigating, using a transport element of the robotic device, to a first location in the elevator lobby to wait for an arrival of the at least one elevator car; determining, at the robotic device, that an elevator car is approaching the elevator lobby; navigating, using the transport element, to a second location for boarding the elevator car that is approaching; monitoring, using one or more sensors of the robotic device, a state of the elevator car to determine when to board the elevator car; in response to determining to board the elevator car, boarding the elevator car by navigating from the second location to a third location within the elevator car; and pressing a target button within the elevator car to select a destination floor.

### BRIEF DESCRIPTION OF THE DRAWINGS

FIG. 1 is a block diagram illustrating a system including a robotic device, according to some embodiments.

FIG. 2 is a block diagram illustrating a configuration of a robotic device, according to some embodiment.

FIG. 3 is a block diagram illustrating a configuration of a control unit associated with a robotic device, according to some embodiments.

FIG. 4 is a schematic illustration of a manipulating element of a robotic device, according to some embodiments.

FIG. 5 is a schematic illustration of a robotic device, according to some embodiments.

FIG. 6 is a schematic illustration of layers of a map of an environment generated by a robotic device, according to some embodiments.

FIG. 7 is a flow diagram illustrating a method involving navigation using an elevator by a robotic device, according to some embodiments.

FIG. 8 is a flow diagram illustrating a method of managing behaviors and/or actions in an elevator lobby by a robotic device, according to some embodiments.

FIG. 9 is a flow diagram illustrating a method of boarding an elevator by a robotic device, according to some embodiments.

FIG. 10 is a flow diagram illustrating a method of managing behaviors and/or actions during an elevator ride by a robotic device, according to some embodiments.

FIG. 11 is a flow diagram illustrating a method of monitoring a relative location of a robotic device to one or more floors, according to some embodiments.

FIG. 12 is a flow diagram illustrating a method of exiting an elevator by a robotic device, according to some embodiments.

FIG. 13 is a flow diagram illustrating a method of preemption or replanning by a robotic device, according to some embodiments.

FIG. 14 is an illustrative representation of an elevator map as interpreted by a robotic device, according to some embodiments.

FIG. 15 depicts a state machine flow for elevator navigation by a robotic device, according to some embodiments.

FIG. 16 depicts a behavior tree for lobby management by a robotic device, according to some embodiments.

FIG. 17 schematically illustrates beam classification by a robotic device, according to some embodiments.

FIG. 18 depicts a decision tree for determining elevator door state by a robotic device, according to some embodiments.

FIG. 19 illustrates an example pipeline for audio signal classification using a convolutional neural network (CNN) model, according to some embodiments.

FIGS. 20A-20C provide a comparison of accuracy, validation loss, and error for a plurality of different algorithms being used to process audio from elevators, according to some embodiments.

FIGS. 21A-21B schematically depict obstacles, fiducials, and other elements in an elevator scene, as viewed by a robotic device, according to some embodiments.

FIG. 22 is an example of a reachability map depicting the probability of a robotic device successfully pressing an elevator button at a grid of base positions inside an elevator car, according to embodiments.

FIG. 23 depicts a set of reachability maps corresponding to each elevator button and elevator tuck pose for elevator cars with different layouts, according to embodiments.

FIG. 24 denotes the subset of reachability maps that the robotic device can use to choose an elevator tuck pose that may enable the robotic device to successfully press a specific button in the elevator car, according to embodiments.

FIG. 25A-25C depict a robotic device in three example elevator tuck poses, according to embodiments.

FIG. 26A depicts a top view of a robotic device pressing an elevator button with a base of the robotic device positioned at an orientation, theta, according to embodiments. FIG. 26B shows the reachability maps generated when the base of the robotic device is positioned at one orientation and a plurality of orientations, respectively, according to embodiments.

FIG. 27A-27B show reachability maps depicting coordinates at which the reachability map can be cropped to reduce a computational load for the robotic device, according to embodiments.

FIG. 28 depicts an example of determination of reachability map(s) given a button locations that is different than the sampled button locations, according to embodiments.

FIG. 29A-29B are flow diagrams illustrating a decision tree for determining a tuck pose and base position for elevator operation, according to embodiments.

FIG. 30 is a flow diagram illustrating a method for determining an elevator tuck pose and base position, according to an embodiment.

FIG. 31 is a flow diagram illustrating a method for determining a tuck pose and base position using a neural network model, according to an embodiment.

FIGS. 32A-32B are a flow diagrams illustrating methods for navigating using an elevator by a robotic device, according to an embodiment.

FIG. 33 is schematic block diagram of a system for operating elevator cars using an intermediate server, according to an embodiment.

FIG. 34 is a flow diagram illustration a method of floor detection training for a robotic device, according to some embodiments.

### DETAILED DESCRIPTION

Systems, apparatus, and methods are described herein for robotic learning, planning, and execution of skills. In some embodiments, systems, apparatus, and methods described herein relate to a robotic apparatus capable of learning skills via human demonstrations, exploration, planning, and interactions and executing learned skills in unstructured environments. In some embodiments, systems, apparatus, and methods described herein relate to a robotic apparatus that can learn, plan, and execute skills including autonomous navigation using an elevator.

### Overview

In some embodiments, systems, apparatus, and methods described herein relate to robots (also referred to herein as “robotic devices”) that can learn and execute skills (e.g., manipulation skills) for navigating using elevators. For example, a robot can use machine-learning techniques to acquire and execute a manipulation skill. After learning a skill, the robot can plan and/or execute the skill in different environments. The robot can learn and/or execute a skill based on sensor data (e.g., perceived visual information, torque or force data, etc.) and/or data from external sources (e.g., hospital databases, elevator management software, etc.).

In some embodiments, a robot can be designed to interact with humans and collaborate with humans to perform tasks. In some embodiments, a robot can use common social behavior to act in a socially predictable and acceptable manner around humans. Robots can also use common social behavior to execute predefined audio files that request for assistance (e.g., help the robot, warn people to move away from the robot, etc.). Robots that are mobile can also be designed to navigate within an environment while interacting with humans in that environment. For example, a robot can be programmed to voice certain phrases to navigate around humans, to move aside to allow humans to pass, and to use eye gaze to communicate intentionality during navigation. In some embodiments, a robot can have sensors that enable it to perceive and track humans in the environment around it, and to use that information to trigger eye gaze and other social behaviors. Robots can also be programmed to voice phrases to instruct a person to open a door, press an elevator button, etc.

In some embodiments, a robotic device can be capable of learning and/or executing skills in an unstructured environment, e.g., a dynamic and/or human environment, where the robotic device does not have complete information of the environment beforehand. Unstructured environments can include, for example, indoor and outdoor settings, and can include one or more humans or other objects that are movable within the environment. Since most natural or real-world environments are unstructured, robotic devices that can adapt and operate in an unstructured environment, such as robotic devices and/or systems described herein, can offer significant improvements over existing robotic devices that are incapable of adapting to an unstructured environment. Unstructured environments can include indoor settings (e.g., buildings, offices, houses, elevators, rooms, etc.) and/or other types of enclosed spaces (e.g., airplanes, trains, and/or other types of movable compartments), as well as outdoor settings (e.g., parks, beaches, outside yards, fields). In an embodiment, robotic devices described herein can operate in an unstructured hospital environment.

In some embodiments, robotic learning can take place at a factory prior to robot deployment, or onsite (e.g., at a hospital) after robot deployment. In some embodiments, a robot can be taught a skill and/or adapted to operate in an environment by users who are not trained in robotics and/or programming. For example, the robot can have a learning algorithm that leverages natural human behavior, and can include tools that can guide a user through the demonstration process.

Examples of learning, planning, and execution by a robotic device are described in U.S. Patent Application Publication No. 2021/0379758, filed Mar. 1, 2021, titled “Systems, apparatus, and methods for robotic learning and execution of skills,” and International Patent Application Publication No. PCT/US2022/015710, filed Feb. 8, 2022, titled “Systems, apparatuses, and methods for robotic learning and execution of skills including navigation and manipulation functions,” the disclosures of each of which are incorporated herein by reference.

In some embodiments, a robotic device can be configured to navigate a building with multiple floors using elevators. Robots can be trained to navigate into and out of an elevator to travel to destinations at different floors. Robots can be trained to identify and determine the floor that the robots are currently at to use the floorplan for that floor to continue navigation. For example, a robot can be configured to determine the floor that is currently on or near while it is riding an elevator. This can allow the robot to determine when to exit the elevator. Robots can be trained to navigate around or through elevators of different types, different button panels, different elevator cars (also referred to herein as “elevators”), different elevator lobbies (also referred to herein as “elevator bays”), and/or the like. Robots can be trained to navigate around or through elevators based on the number of occupants (e.g., doctors, patients, nurses, etc.) and obstacles (hospital beds, wheelchairs, etc.). Robots can be trained to quickly enter and exit elevators without getting stuck. For instance, a robot can manipulate the orientation of the robot's arms or body when navigating around obstacles or positioning inside an elevator. The robot can also voice phrases requesting for assistance when obstacles are impeding the robot's path.

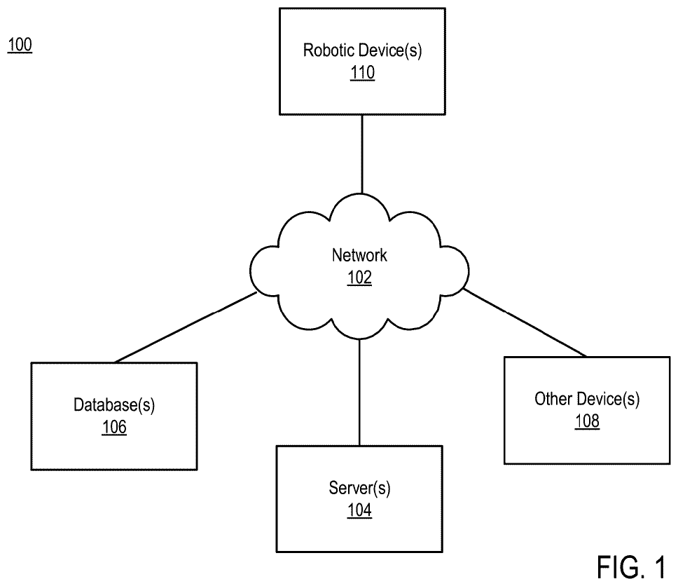

FIG. 1 is a high-level block diagram that illustrates a system 100, according to some embodiments. System 100 can include one or more robotic device(s) 110. The robotic device(s) 110 can be communicably coupled to one or more database(s) 106, server(s) 104, and/or other device(s) 108 via network 102.

Network 102 can be any type of network (e.g., a local area network (LAN), a wide area network (WAN), a virtual network, a telecommunications network) implemented as a wired network and/or wireless network and used to operatively couple compute devices, including robotic device(s) 110, database(s) 106, server(s) 104, and other device(s) 108. As described in further detail herein, in some embodiments, for example, the compute devices are connected to each other via an Internet Service Provider (ISP) and the Internet (e.g., network 102). In some embodiments, a connection can be defined, via network 102, between any two compute devices. As shown in FIG. 1, for example, a connection can be defined between robotic device 110 and any one of, database(s) 106, server(s) 104, and/or other device(s) 108. In some embodiments, the compute devices can communicate with each other (e.g., send data to and/or receive data from) and with the network 102 via intermediate networks and/or alternate networks (not shown in FIG. 1). Such intermediate networks and/or alternate networks can be of the same type and/or a different type of network as network 102. Each compute device can be any type of device configured to send data over the network 102 to send and/or receive data from one or more of the other compute device.

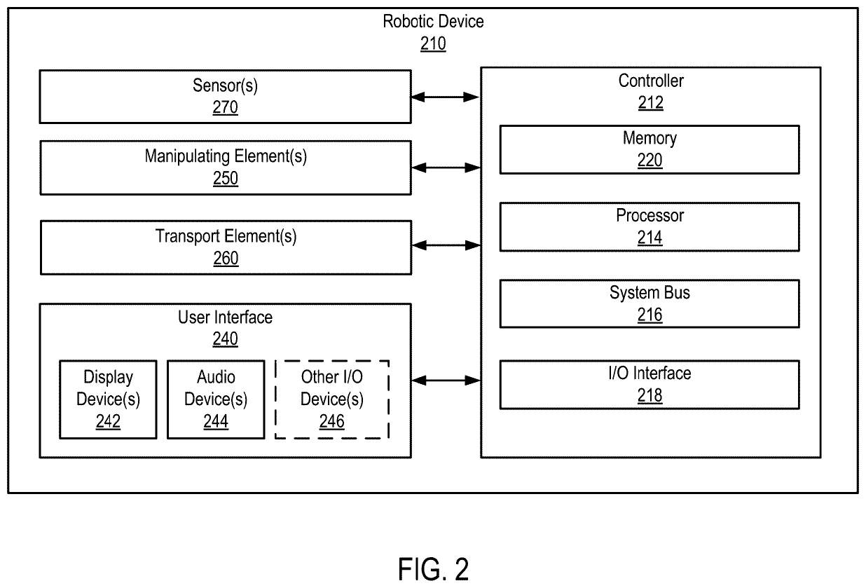

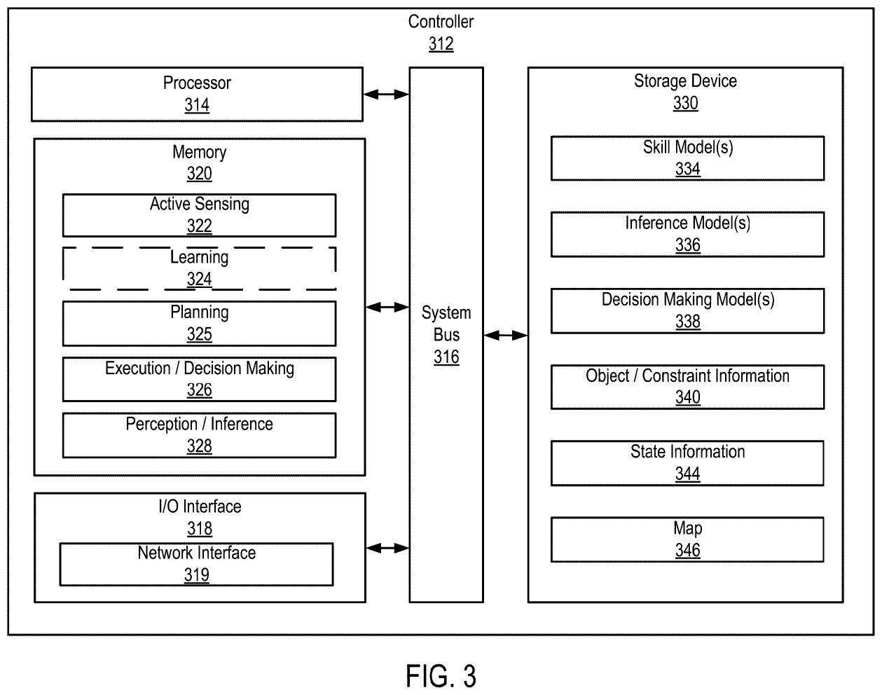

Robotic device(s) 110 can be configured to perceive information about an environment, learn skills, plan and/or execute trajectories, etc. Robotic device(s) 110 can be configured to interact with the environment and/or learn environmental constraints via human demonstrations and inputs, exploration, and/or execute those skills in the environment. In some embodiments, robotic device(s) 110 can learn, plan, and/or execute skills associated with autonomous navigation using elevators. A more detailed view of an example robotic device is depicted and described with reference to FIGS. 2 and 3.

Robotic device(s) 110 can send and/or receive data to and/or from other robotic devices via network 102. For example, a robotic device 110 can send information that it perceives about an environment (e.g., a location of an object) to other robotic devices, and can receive information about the environment from the other robotic devices. Robotic device(s) 110 can also send and/or receive information to and/or from one another to learn and/or execute a skill. For example, a robotic device 110 can learn a skill in an environment and send a model representing that learned skill to the other robotic devices, and upon receiving that model, can use it to execute the skill in the same or a different environment. A robotic device 110 can be in a location that is the same as or different from other robotic devices. For example, robotic device 110 and the other robotic devices can be located in the same room of a building (e.g., a hospital building) such that they can learn and/or execute a skill together (e.g., moving a heavy or large object). Alternatively, a robotic device 110 can be located on a first floor of a building (e.g., a hospital building), and the other robotic devices can be located on a second floor of a building, and they can communicate with one another to relay information about the different floors to one another (e.g., where objects are located on those floors, where a resource may be, etc.). In some embodiments, a robotic device 110 located at a first location or site (e.g., a first hospital) can learn to navigate (e.g., using an elevator), and can transmit models, plans, and/or other information associated with the navigation to other compute devices (e.g., server 104) and/or other robotic devices located in the location or at other locations.

In some embodiments, server(s) 104 can be a dedicated server that manages robotic device 110 and/or other device(s) 108. Server(s) 104 can be in a location that is the same as or different from robotic device(s) 110 and/or other device(s) 108. For example, server(s) 104 can be located in the same building as one or more robotic devices (e.g., a hospital building), and be managed by a local administrator (e.g., a hospital administrator). Alternatively, server(s) 104 can be located at a remote location (e.g., a location associated with a manufacturer or provider of the robotic device). In some embodiments, the robotic device 110 can be configured to capture data and/or learn or execute skills and can send this data, skills, etc. to server(s) 104, such that server(s) 104 can transfer to other device(s) 108 such as other robotic devices located remotely from robotic device 110. In other words, robotic device 110 can be trained with training data at one or more elevators at a specific building/hospital, and can pass this data and/or training along to other robotic devices at the same building or site or a different one.

Database(s) 106 can store information that can be accessible to a robotic device 110. In some embodiments, a database 106 can be a hard drive, a database, a cloud storage, a network-attached storage device, or other data storage device. In some embodiments, database(s) 106 can store sensor data including information regarding one or more components of robotic device 110, learned models, marker location information, etc. In some embodiments, database(s) 106 can store information about patients, hospital personnel, hospital supplies and/or equipment, etc.

In some embodiments, system 100 can include other device(s) 108 that can be configured to run and/or execute certain functions. In a hospital setting, for example, other device(s) 108 can be a diagnostic and/or treatment device that is capable of connecting to network 102 and communicating with other compute devices, including robotic device 110 and/or database(s) 106. In some embodiments, other device(s) 108 can include compute device(s) that are operated by an administrator, e.g., for controlling and/or providing guidance to one or more robotic device(s) 110.

Any compute device as described herein (e.g., robotic device(s) 110, database(s) 106, server(s) 104, and other device(s) 108) can include a user interface that enables a user (e.g., a nearby user or a robot supervisor), to control the operation of a robotic device 110. For example, the user can interrupt and/or modify the execution of one or more actions performed by the robotic device 110. These actions can include, for example, navigation behaviors, manipulation behaviors, head behaviors, sounds/lights, and/or other components of robotic device 110. In some embodiments, a robot supervisor can remotely monitor the robotic device 110 and control their operation for safety reasons. For example, the robot supervisor can command robotic device 110 to stop or modify an execution of an action to avoid endangering a human or causing damage to robotic device 110 or another object in an environment. In some embodiments, a nearby user can guide or demonstrate to robotic device 110 an action. In some embodiments, robotic device 110 can be configured to solicit user intervention at specific points during its execution of an action. For example, robotic device 110 can solicit user intervention at points when robotic device 110 cannot confirm certain information about itself and/or environment around itself, when the robotic device cannot determine a trajectory for completing an action or navigating to a specific location, when robotic device 110 has been programmed in advance to solicit user input (e.g., during learning using an interactive learning template, as further described below), etc. In some embodiments, a robotic device can request feedback from a user at specific points during learning and/or execution. For example, robotic device 110 can prompt a user to specify what information it should collect (e.g., information associated with a manipulation element or a transport element, information associated with the surrounding environment) and/or when to collect information (e.g., the timing of keyframes during a demonstration). Alternatively or additionally, robotic device 110 can request that a user tag the robotic device's past or current behavior in a specific context as a positive or negative example of an action. The robotic device 110 can be configured to use this information to improve future execution of the action in the specific context.

FIG. 2 schematically illustrates a robotic device 210, according to some embodiments. Robotic device 210 includes a controller 212, a user interface 240, at least one manipulating element(s) 250, and at least one sensor(s) 270. Additionally, in some embodiments, robotic device 210 optionally includes at least one transport element(s) 260. Controller 212 includes a memory 220, a processor 214, a system bus 216, and at least one input/output interface (“I/O interface”) 208. Memory 220 can be, for example, a random access memory (RAM), a memory buffer, a hard drive, a database, an erasable programmable read-only memory (EPROM), an electrically erasable read-only memory (EEPROM), a read only memory (ROM), and/or so forth. In some embodiments, memory 220 stores instructions that cause processor 214 to execute modules, processes, and/or functions associated with sensing or scanning an environment, learning a skill, and/or executing a skill.

Processor 214 of controller 212 can be any suitable processing device configured to run and/or execute functions associated with viewing an environment, learning a skill, and/or executing a skill. For example, processor 214 can be configured to generate a model for a skill based on sensor information, or execute a skill by generating, using a model, a trajectory for performing a skill, as further described herein. More specifically, processor 214 can be configured to execute modules, functions, and/or processes. In some embodiments, processor 214 can be a general purpose processor, a Field Programmable Gate Array (FPGA), an Application Specific Integrated Circuit (ASIC), a Digital Signal Processor (DSP), a Graphics Processing Unit (GPU), and/or the like.

System bus 216 can be any suitable component that enables processor 214, memory 220, storage 230, and/or other components of controller 212 to communicate with each other. I/O interface(s) 208, connected to system bus 216, can be any suitable component that enables communication between internal components of controller 212 (e.g., processor 214, memory 220, storage 230) and external input/output devices, such as user interface 240, manipulating element(s) 250, transport element(s) 260, and sensor(s) 270.

User interface 240 can include one or more components that are configured to receive inputs and send outputs to other devices and/or a user operating a device, e.g., a user operating robotic device 210. For example, user interface 240 can include a display device(s) 242 (e.g., a display, a touch screen, etc.), an audio device(s) 244 (e.g., a microphone, a speaker), and optionally one or more additional input/output device(s) (“I/O device(s)”) 246 configured for receiving an input and/or generating an output to a user.

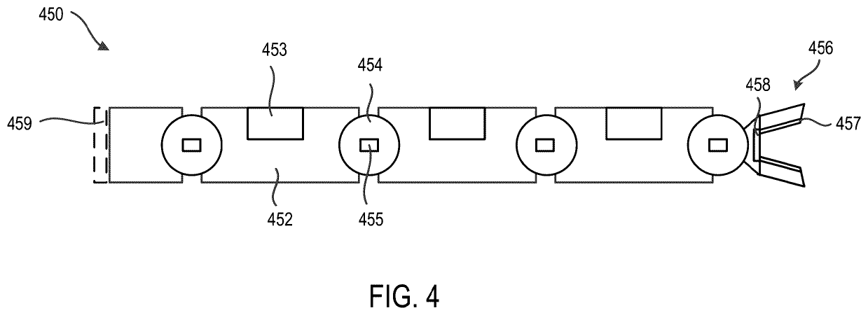

Manipulating element(s) 250 can be any suitable component that is capable of manipulating and/or interacting with a stationary and/or moving object, including, for example, a human. In some embodiments, manipulating element(s) 250 can include a plurality of segments that are coupled to one another via joints that can provide for translation along and/or rotation about one or more axes. Manipulating element(s) 250 can optionally include an end effector that can engage with and/or otherwise interact with objects in an environment. For example, manipulating element can include a gripping mechanism that can releasably engage (e.g., grip) objects in the environment to pick up and/or transport the objects. Other examples of end effectors include, for example, vacuum engaging mechanism(s), magnetic engaging mechanism(s), suction mechanism(s), and/or combinations thereof. In some embodiments, one or more manipulating element(s) 250 can be retractable into a housing of the robotic device 210 when not in use to reduce one or more dimensions of the robotic device. In some embodiments, manipulating element(s) 250 can include a head or other humanoid component configured to interact with an environment and/or one or more objects within the environment, including humans. In some embodiments, manipulating element(s) 250 can include a transport element or base (e.g., transport element(s) 260). A detailed view of an example manipulating element is depicted in FIG. 4.

Transport element(s) 260 can be any suitable components configured for movement such as, for example, a wheel or a track. One or more transport element(s) 260 can be provided on a base portion of robotic device 210 to enable robotic device 210 to move around an environment. For example, robotic device 210 can include a plurality of wheels that enable it to navigate around a building, such as, for example, a hospital. Transport element(s) 260 can be designed and/or dimensioned to facilitate movement through tight and/or constrained spaces (e.g., small hallways and corridors, small rooms such as supply closets, etc.). In some embodiments, transport element(s) 260 can be rotatable about an axis and/or movable relative to one another (e.g., along a track). In some embodiments, one or more transport element(s) 260 can be retractable into a base of the robotic device 210 when not in use to reduce one or more dimensions of the robotic device. In some embodiments, transport element(s) 260 can be or form part of a manipulating element (e.g., manipulating element(s) 250).

Sensor(s) 270 can be any suitable component that enables robotic device 210 to capture information about the environment and/or objects in the environment around robotic device 210. Sensor(s) 270 can include, for example, image capture devices (e.g., cameras, such as a red-green-blue-depth (RGB-D) camera or a webcam), audio devices (e.g., microphones), light sensors (e.g., light detection and ranging or lidar sensors, color detection sensors), proprioceptive sensors, position sensors, tactile sensors, force or torque sensors, temperature sensors, pressure sensors, motion sensors, sound detectors, etc. For example, sensor(s) 270 can include at least one image capture device such as a camera for capturing visual information about objects and the environment around robotic device 210. In some embodiments, sensor(s) 270 can include haptic sensors, e.g., sensors that can convey forces, vibrations, touch, and other non-visual information to robotic device 210.

In some embodiments, robotic device 210 can have humanoid features, e.g., a head, a body, arms, legs, and/or a base. For example, robotic device 210 can include a face with eyes, a nose, a mouth, and other humanoid features. These humanoid feature can form and/or be part of one or more manipulating element(s). While not schematically depicted, robotic device 210 can also include actuators, motors, couplers, connectors, power sources (e.g., an onboard battery), and/or other components that link, actuate, and/or drive different portions of robotic device 210.

FIG. 3 is a block diagram that schematically illustrates a controller 312, according to some embodiments. Controller 312 can include similar components as controller 212, and can be structurally and/or functionally similar to controller 212. For example, controller 312 includes a processor 314, a memory 320, I/O interface(s) 308, a system bus 316, which can be structurally and/or functionally similar to processor 214, memory 220, I/O interface(s) 208, system bus 216, respectively. Controller 312 can be located on a robotic device and/or at a remote server that is connected to one or more robotic devices.

Memory 320 stores instructions that can cause processor 314 to execute modules, processes, and/or functions, illustrated as active sensing 322, planning 325, execution/decision making 326, and perception/inference 328, and optionally learning 324. Active sensing 322, learning 324, planning 325, execution/decision making 326, and perception/inference 328 can be implemented as one or more programs and/or applications that are tied to hardware components (e.g., a sensor, a manipulating element, an I/O device, a processor, etc.). Active sensing 322, learning 324, planning 325, execution/decision making 326, and perception/inference 328 can be implemented by one robotic device or multiple robotic devices. For example, a robotic device can be configured to implement active sensing 322, learning 324, planning 325, execution/decision making 326, and perception/inference 328. As another example, a robotic device can be configured to implement active sensing 322, learning 324, planning 325, and execution/decision making 326. As another example, a robotic device can be configured to implement active sensing 322, learning 324, planning 325, execution/decision making 326, and perception/inference 328. While not depicted, memory 320 can also store programs and/or applications associated with an operating system, and general robotic operations (e.g., power management, memory allocation, etc.).

In some embodiments, active sensing 322 can include active sensing or scanning of an environment, as described herein. In some embodiments, active sensing 322 can include active scanning of an environment and/or sensing or perceiving information associated with the environment, object(s) within the environment (e.g., including humans within the environment), and/or one or more conditions associated with a robotic device or system.

Learning 324 can include modules, processes, and/or functions, that when implemented cause the robotic device to learn actions, skills, environmental constraints, and/or other information associated with autonomous activity by the robotic device. In some embodiments, skill model(s) 334 can be generated and/or updated based on learning 324. In some embodiments, learning 324 can include configuring a robotic device with specific information such as elevator maps, hallway maps, floorplans, and/or the like, of specific buildings that the robotic device is operating in. Learning 324 can include setting predefined configurations for a robotic device such as, for example, dimensions of a safety bubble, thresholds for reactions (e.g., warnings, request for assistance, etc.). Planning 325 can include teaching a robotic device boarding and/or exit procedures for different elevators, doors, etc. in a hospital the robotic device is stationed at.

Planning 325 can include modules, processes, and/or functions, that allow or, when implemented, cause the robotic device to generate plans or trajectories for executing one or more actions or skills. Plans or trajectories, as further described herein, are paths between points represented as future positions of a robotic device between a first time (t) and a future time (t+n, where n can represent the number of timesteps into the future). For example, a trajectory can be represented as {(t₁, x₁, y₁, theta₁), (t₂, x₂, y₂, theta₂), . . . (tₙ, x_{goal}, y_{goal}, theta_{goal})}, where goal represents a final waypoint or desired position of a robotic device. In some implementations, planning 325 can include pre-planning for generation of a cache of plans for executing an action or skill, where each plan can be associated with various conditions and/or information, such as, for example, sensor data, elevator data, contextual information, environmental constraints, and/or the like. In some embodiment, planning 325 can include live planning or real-time determination of a plan for executing an action or skill.

Execution/decision making 326 can include modules, processes, and/or functions, that when implemented cause the robotic device to execute a plan for an action and/or skill, e.g., from planning 325. In some embodiments, execution/decision making 326 can include determination of which action and/or skill to execute in a given environment. In some embodiments, execution/decision making 326 can include preempting execution of certain actions or skills (or preempting continued execution of certain actions or skills) based on changes in a dynamic environment. For example, execution/decision making 326 can be configured to determine a direction and/or actions for the robotic device to take (e.g., execute an alternate route, exit a desired floor in a building, press one or more buttons on an elevator to arrive and exit at desired floor, predict arrival of elevator car, etc.). In a hospital setting, execution/decision making 326 can enable the robotic device to move through an environment while avoiding people (e.g., doctors, nurses, staff, patients, etc.), objects (e.g., wheelchairs, hospital beds, etc.), determine whether to wait or call for an elevator, identify safe space for the robotic device to occupy in an elevator car, etc.

Perception/inference 328 include modules, processes, and/or functions, that when implemented cause the robotic device to perceive and/or infer information about objects in an environment. Perception/inference 328 can operate based on information collected by one or more robotic devices (e.g., sensor data) and/or information associated with state information, data tracking and/or analytics, etc. In some embodiments, perception/inference 328 can be configured to access and/or obtain information from third-party systems (e.g., security system data, hospital floorplan data, elevator system data, etc.), and use and/or analyze that data, with or without data collected by one or more robotic devices, to perform data tracking, analysis, etc. In some embodiments, perception/inference 328 can be configured to analyze information associated with humans, such as hospital staff and/or patients within a hospital.

Controller 312 can include or be operatively coupled to a storage device 330. Storage device 330 stores information relating to an environment and/or objects within the environment, learning and/or execution of skills (e.g., tasks and/or social behaviors), and/or state information of a robotic device. Storage 330 stores, for example, state information 344, skill model(s) 334, inference model(s) 336, decision making model(s) 338, object/constraint information 340, state information 334, map 346, machine learning libraries, and/or the like.

Object/constraint information 340 can include information relating to physical object(s) in an environment. Objects can include any type of physical object that is located within the environment, including objects that define a space or an opening (e.g., surfaces or walls that define a doorway, hospital beds, wheelchairs, etc.). Objects can be stationary or mobile. Examples of objects in an environment, such as, for example, a hospital, include equipment, supplies, instruments, tools, furniture, and/or humans (e.g., nurses, doctors, patients, etc.). Object/constraint information 340 can include information identifying or quantifying different features of an object, such as, for example, location, color, shape, and surface features. Object/constraint information 340 can also identify codes, symbols, and other markers that are associated with a physical object, e.g., Quick Response or “QR” codes, barcodes, tags, etc. In some embodiments, object/constraint information 340 can include information characterizing an object within the environment, e.g., an elevator car as being crowded, a button panel in an elevator car to be a specific type of button panel, indicator(s) in elevator lobbies, hallways, and/or elevators, etc. Object/constraint information 340 can enable controller 312 to identify physical object(s) in the environment. Object/constraint information 340 can include information associated with objects and/or conditions within an environment that may restrict the operation of a robotic device within the environment. For example, object/constraint information 340 can include information associated with the size, configuration, and/or location of objects within an environment (e.g., supply bin, room, doorway, etc.), and/or information that indicates that certain areas (e.g., a room, a hallway, etc.) have restricted access. Object/constraint information 340 may affect the learning and/or execution of one or more actions within an environment. As such, an environmental constraint may become part of each model for a skill that is executed within a context including the environmental constraint.

State information 344 can include information regarding a state of a robotic device (e.g., robotic device 210) and/or an environment in which the robotic device is operating (e.g., a building, such as, for example, a hospital). Map 346 can include information associated with a representation of an environment (e.g., map and/or representation 600) and/or information that is obtained from third-party systems (e.g., hospital electronic medical records, security system data, insurance data, vendor data, etc.) that is tracked and/or analyzed, e.g., by a data tracking & analytics element, such as perception/inference 328 or processor 302 executing perception/inference 328. Examples of map 346 include floor plan data, elevator system data, room data, hallway data, emergency exit data, etc.

In some embodiments, state information 344 can indicate a location of the robotic device within the environment, such as, for example, a room, a floor, an enclosed space, an elevator, etc. For example, state information 344 can indicate a location of the robotic device within a map. State information 344 can also include, for example, information identifying designated spaces (e.g., safe zones, hazard zones, etc.), hazard cues, and/or the like. In some cases, state information 344 can include dimensions of designated spaces in 3D. State information 344 can also include the location(s) of one or more objects (or markers representing and/or associated with objects) within the environment, e.g., within a map. Thus, state information 344 can identify a location of a robotic device relative to one or more objects.

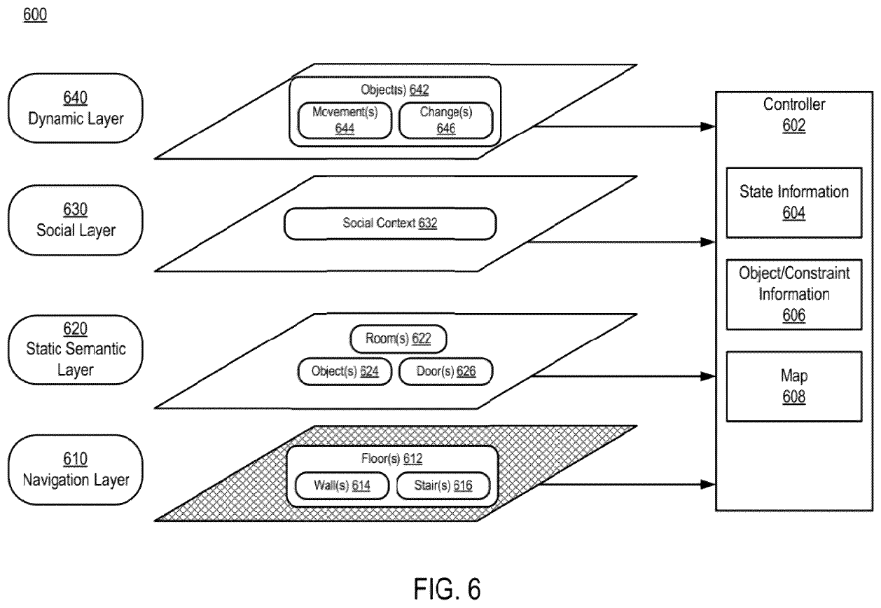

The map 346 can include a stored representation of the environment along with static and/or dynamic information regarding objects (e.g., supplies, equipment, etc.) within the environment and social context information associated with humans and/or social settings within the environment, such as that shown in representation 600 in FIG. 6. For example, the representation 600 can include, for example, a navigation layer 610, a static semantic layer 620, a social layer 630, and a dynamic layer 640. Navigation layer 610 provides a general layout or map of the building, which may identify a number of floor(s) 612 with wall(s) 614, stair(s) 616, and other elements built into the building (e.g., hallways, openings, boundaries). Static semantic layer 620 identifies objects and/or spaces within the building, such as elevator(s) 622, object(s) 624, door(s) 626, etc. Static semantic layer 620 can identify which elevator(s) 622 or other spaces are accessible or not accessible to a robotic device. In some embodiments, static semantic layer 620 can provide a three dimensional map of the objects located within a building. Social layer 630 provides social context information 632. Social context information 632 includes information associated with humans within the building. Dynamic layer 640 provides information on object(s) and other elements within a building that may move and/or change over time. For example, dynamic layer 640 can track movement(s) 644 and/or change(s) 646 associated with object(s) 642. In an embodiment, dynamic layer 640 can monitor the expiration date of an object 642 and identify when that object 642 has expired.

Information in representation 600 can be accessible to and/or managed by a control unit 602 (e.g., structurally and/or functionally similar to controller 312), e.g., of a robotic device. Control unit 602 can include similar components as other control units described herein (e.g., control units 202 and/or 302). Control unit 602 can include a storage device (similar to other storage elements described herein, such as, for example, storage device 330) that stores state information 604 (e.g., similar to state information 344), object/constraint information 606 (e.g., similar to object/constraint information 340), and/or map 608 (e.g., similar to map 346). Control unit 602 can be located on a robotic device and/or at a remote server that is connected to one or more robotic devices. Robotic device(s) can be configured to update and maintain state information 604, object/constraint information 606, and/or map 608, as the robotic device(s) collect information on their surrounding environment.

Information learned by a robotic device, e.g., from active sensing 322, learning 324, planning 325, execution/decision making 326, and/or perception/inference 328 can feed into the different layers of the representation 600 and be organized for future reference by the robotic device (and/or other robotic devices). For example, a robotic device may rely on information learned about different objects within an environment (e.g., an elevator or door) to decide how to arbitrate between different behaviors (e.g., waiting for elevator doors to be opened before entering elevator car, waiting for people to move prior to entering/exiting elevator car, seeking assistance to press a button for a direction request for an elevator, seeking assistance to press a button for desired floor in the elevator car, seeking assistance to clear out a path for the robotic device, etc.), as further described herein.

Referring back to FIG. 3, skill model(s) 334 include models that have been generated for performing different actions, and represent skills that have been learned by a robotic device (e.g., by implementing learning 324). In some embodiments, skill model(s) 334 are models that can be used to learn and/or execute various actions or skills, including tasks and/or behaviors. For example, skill model(s) 334 can include information associated with object(s) that are involved in the execution of a skill (e.g., an object that is manipulated by the robotic device, an object that a robotic device interacts with during execution of a skill, an object that a robotic device takes into account while executing a skill). In some embodiments, each model 334 is associated with a set of markers that are tied to different physical objects in an environment. Marker information can indicate which markers are associated with a particular model 334. Each model 334 can also be associated with sensory information that is collected, e.g., via one or more sensors of a robotic device, during kinesthetic teaching and/or other demonstrations of a skill. Sensory information can optionally include manipulating element information associated with a manipulating element of a robotic device as it performs an action during a demonstration. Manipulating element information can include, for example, joint positions and configurations, end effector positions and configurations, base or transport element positions and configurations, and/or forces and torques acting on joints, end effectors, transport elements, etc. Manipulating element information can be recorded at specific points during a demonstration and/or execution of a skill (e.g., keyframes), or alternatively, throughout a demonstration and/or execution of a skill. Sensory information can also include information associated with an environment in which a skill is demonstrated and/or executed, e.g., location of markers in the environment. In some embodiments, each model 334 can be associated with success criteria. Success criteria can be used to monitor the execution of a skill. In some embodiments, success criteria can include information associated with visual and haptic data that are perceived using one or more sensors, e.g., cameras, force/torque sensors, etc. Success criteria can be, for example, tied to visually detecting movement of an object, sensing a force that is acting on a component of the robotic device (e.g., a weight from an object), sensing an engagement between a component of the robotic device and an object (e.g., a change in pressure or force acting on a surface), etc.

Inference model(s) 336 include models that can infer or predict different information about an object in an environment, the environment, a robotic device, and the like. In some embodiments, inference model(s) 336 can include an algorithm for determining the arrival of an elevator and/or which floor an elevator is on. For example, inference model(s) 336 can include a machine learning algorithm such as a CNN model that can be used to process audio data (and/or other types of sensor data) to determine whether an elevator is arriving. In some embodiments, inference model(s) 336 can include algorithms for predicting changes in a dynamic environment (e.g., human movement, human behavior, etc.).

Decision making model(s) 338 include models that guide a robotic device in implementing one or more actions (e.g., executing one or more trajectories or plans). In some embodiments, decision making model(s) 338 can be associated with preempting or halting execution of a particular action or skill, e.g., to avoid a safety issue or impossible movement. In some embodiments, decision making model(s) 338, when implemented by processor 314, enable a robotic device to arbitrate or decide between multiple plans for execution.

In some embodiments, storage device 330 can include machine learning libraries, which can include modules, processes, and/or functions relating to different algorithms for machine learning and/or model generation of different skills. In some embodiments, machine learning libraries can include methods such as Convolutional Neural Networks, Bayesian Belief Networks, and Hidden Markov Models (HMMs). An example of an existing machine learning library in Python is scikit-learn. Storage 330 can also include additional software libraries relating to, for example, robotics simulation, motion planning and control, kinematics teaching and perception, etc. While specific machine learning models are described herein, it can be appreciated that machine learning libraries can include additional forms of learning, e.g., for detecting objects (e.g., people, doors, buttons), elevator doors opening and/or closing, selecting a base position in the elevator for pressing an elevator button, etc.

In some embodiments, an initial set of state information 344, object/constraint information 340, etc. and/or algorithms (e.g., model(s) 334, 336, 338) can be provided to a robotic device, e.g., via a remote administrator or supervisor. The robotic device can adapt and/or add to its knowledge of the state information 344, object/constraint information 340, and/or algorithms based on its own interactions, demonstrations, etc. with an environment or humans within the environment (e.g., patients, nurses, doctors, etc.) and/or via additional user input. Alternatively or additionally, a robot supervisor can update the robotic device's knowledge of the state information 344, object/constraint information 340, and/or algorithms based on new information collected by the robotic device or other robotic device(s) (e.g., other robotic device(s) within similar or the same environment, e.g., a hospital) and/or provided to the robotic supervisor by external parties (e.g., suppliers, administrators, manufacturers, etc.). Such updates can be repeatedly and/or continuously provided, as new information about an environment or skill is provided to the robotic device and/or robot supervisor.

I/O interface(s) 318 can be any suitable component(s) that enable communication between internal components of controller 312 and external devices, such as a user interface, a manipulating element, a transport element, and/or compute device. I/O interface(s) 318 can include a network interface 319 that can connect controller 312 to a network (e.g., network 102, as depicted in FIG. 1). Network interface 319 enables communications between controller 312 (which can be located on a robotic device or another network device in communication with one or more robotic devices) and a remote device, such as a compute device that can be used by a robot supervisor to monitor and/or control one or more robotic devices. Network interface 319 can be configured to provide a wireless and/or wired connection to a network (e.g., network 102).

FIG. 4 schematically illustrates a manipulating element 450, according to some embodiments. Manipulating element 450 can form a part of a robotic device, such as, for example, robotic device 102 and/or 200. Manipulating element 450 can be implemented as an arm that includes two or more segments 452 coupled together via joints 454. Joints 454 can allow one or more degrees of freedom. For example, joints 454 can provide for translation along and/or rotation about one or more axes. In an embodiment, manipulating element 450 can have seven degrees of freedom provided by joints 454. While four segments 452 and four joints 454 are depicted in FIG. 4, one of ordinary skill in the art would understand that a manipulating element can include a different number of segments and/or joints.

Manipulating element 450 includes an end effector 456 that can be used to interact with objects in an environment. For example, end effector 456 can be used to engage with and/or manipulate different objects. Alternatively or additionally, end effector 456 can be used to interact with movable or dynamic objects, including, for example, humans. In some embodiments, end effector 456 can be a gripper that can releasably engage or grip one or more objects. For example, end effector 456 implemented as a gripper can pick up and move an object from a first location (e.g., a supply closet) to a second location (e.g., an office, a room, etc.).

A plurality of sensors 453, 455, 457, and 458 can be disposed on different components of manipulating element 450, e.g., segments 452, joints 454, and/or end effector 456. Sensors 453, 455, 457, and 458 can be configured to measure sensory information, including environmental information and/or manipulating element information. Examples of sensors include position encoders, torque and/or force sensors, touch and/or tactile sensors, image capture devices such as cameras, temperature sensors, pressure sensors, light sensors such as lidar sensors, microphones, etc. In some embodiments, sensor 453 disposed on a segment 452 can be a camera that is configured to capture visual information about an environment. In some embodiments, sensor 453 disposed on a segment 452 can be an accelerometer configured to enable measurement of an acceleration, and/or calculation of speed of movement, and/or a position, of segment 452. In some embodiments, sensor 455 disposed on a joint 454 can be a position encoder configured to measure a position and/or configuration of joint 454. In some embodiments, sensor 455 disposed on a joint 454 can be a force or torque sensor configured to measure a force or torque applied to joint 454. In some embodiments, sensor 458 disposed on end effector 456 can be a position encoder and/or a force or torque sensor. In some embodiments, sensor 457 disposed on end effector 456 can be a touch or tactile sensor configured to measure an engagement between end effector 456 and an object in the environment. Alternatively or additionally, one or more of sensors 453, 455, 457, and 458 can be configured to record information about one or more objects and/or markers in the environment. For example, sensor 458 disposed on end effector 456 can be configured to track a location of an object in the environment and/or a position of the object relative to end effector 456. In some embodiments, one or more of sensors 453, 455, 457, and 458 can also track whether an object, such as a human, has moved in the environment. Sensors 453, 455, 457, and 458 can send the sensory information that they record to a compute device located on a robotic device (e.g., an onboard control unit such as, for example, control unit 202 and/or 302), or sensors 453, 455, 457, and 458 can send the sensory information to a remote compute device (e.g., a server such as, for example, server 120).

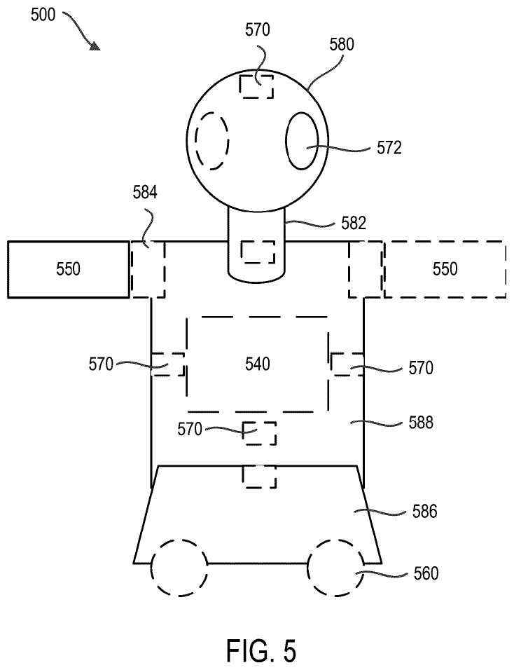

Manipulating element 450 can optionally include a coupling element 459 that enables manipulating element 450 to be releasably coupled to a robotic device, such as any of the robotic devices described herein. In some embodiments, manipulating element 450 can be coupled to a fixed location of the robotic device and/or be capable of being coupled to multiple locations of the robotic device (e.g., a right side or a left side of a body of robotic device, as shown in FIG. 5). Coupling element 459 can include any type of mechanism that can couple manipulating element 350 to the robotic device, such as, for example, a mechanical mechanism (e.g., a fastener, a latch, a mount), a magnetic mechanism, a friction fit, etc.

FIG. 5 schematically illustrates a robotic device 500, according to some embodiments. Robotic device 500 includes a head 580, a body 588, and a base 586. Head 580 can be connected to body 588 via a segment 582 and one or more joints (not depicted). Segment 582 can be movable and/or flexible to enable head 580 to move relative to body 588. Head 580, segment 582, etc. can be examples of manipulating element(s), and include similar functionality and/or structure as other manipulating element(s) described herein.

Head 580 includes one or more image capture devices 572 and/or other sensors 570. Image capture device 572 and/or other sensors 570 (e.g., lidar sensors, motion sensors, microphones etc.) can enable robotic device 500 to scan an environment and obtain a representation (e.g., a visual representation or other semantic representation) of the environment. In some embodiments, image capture device 572 can be a camera. In some embodiments, image capture device 572 can be movable such that it can be used to focus on different areas of the environment around robotic device 500. Image capture device 572 and/or other sensors 570 can collect and send sensory information to a compute device or processor onboard robotic device 500, such as, for example, control unit 202 or 302. In some embodiments, head 580 of robotic device 500 can have a humanoid shape, and include one or more human features, e.g., eyes, nose, mouth, ears, etc. In such embodiments, image capture device 572 and/or other sensors 570 can be implemented as one or more human features. For example, image capture device 572 can be implemented as eyes on head 580. In some cases, sensors 570 including a microphone can receive audio data, e.g., from a user speaking to the robotic device or from objects (e.g., arriving elevators), to execute actions, perform inferences, and/or the like.

In some embodiments, robotic device 500 can use image capture device 572 and/or other sensors 570 to scan an environment for information about objects in the environment, e.g., physical structures, devices, articles, humans, etc. Robotic device 500 can engage in active sensing, or robotic device 500 can initiate sensing or scanning in response to a trigger (e.g., an input from a user, a detected event or change in the environment). In some embodiments, robotic device 500 can engage in adaptive sensing where sensing can be performed based on stored knowledge and/or a user input. For example, robotic device 500 can identify an area in the environment to scan for an object based on prior information that it has on the object.

In some embodiments, robotic device 500 can also know to sense or scan different areas of a scene more closely based on an input by a human. For example, a human can indicate to robotic device 500 that a certain area of a scene includes one or more objects of interest, and robotic device 500 can scan those areas more closely to identify those objects. In such embodiments, robotic device 500 can include an input/output device 540, such as a display with a keyboard or other input device, and/or a touchscreen, as schematically depicted in FIG. 5. In some embodiments, robotic device 500 can scan an environment and identify that an object, such as, for example, a human, is moving in the environment. In some embodiments, robotic device 500 can engage in active sensing such that it can adjust its actions in near real-time.

As schematically depicted in FIG. 5, base 586 optionally can include one or more transport elements implemented as wheels 560. Wheels 560 can enable robotic device 500 to move around an environment, e.g., a hospital. Robotic device 500 also includes at least one manipulating element implemented as arms 550. Arms 550 can be structurally and/or functionally similar to other manipulating elements described herein, e.g., manipulating element 450. Arms 550 can be fixedly attached to body 588 of robotic device 500, or optionally, manipulating element 550 can be releasably coupled to body 588 via a coupling element (e.g. coupling element 459) that can attach to a coupling portion 584 of robotic device 500. Coupling portion 584 can be configured to engage with coupling element 459, and provide an electrical connection between arm 550 and an onboard compute device (e.g., control unit 202 or 302), such that the onboard compute device can power and/or control components of arm 550, and receive information collected by sensors disposed on manipulating element 550 (e.g., sensors 453, 455, 457, and 458). Head component 580 can contain lights that are connected to control unit 202 or 302 and give information about robot state to those around the robot. In some embodiments, head component 580 can contain one or more lights (e.g., on a headband) that are connected to control unit 202 or 302 and give information about robot state to those around the robot.

### Elevator Navigation

In some embodiments, robotic devices described herein can be configured to navigate using an elevator. Autonomous elevator navigation, however, carries various challenges, including, for example, speed of elevator opening and closing, tight physical constraints and sharing of space, etc. Robotic devices as described herein can recognize and/or interact with one or more of: elevator interfaces including buttons and/or API interfaces, various ways in which an elevator may be occupied, recovery behavior to quickly enter and exit the elevator without getting stuck, indicators of what floor an elevator or a robotic device is on (e.g., as the elevator is moving), and indicators of the arrival of an elevator.

In some embodiments, robotic devices as described herein can be trained with information about elevator infrastructure and building structure of various buildings. Robots can use models or maps of elevator layouts and floor layouts to navigate efficiently and automatically. Robots can be configured to recognize, negotiate, and/or interact with humans and obstacles. For example, robots can conduct a dialogue with humans such as requesting for assistance, warning humans to watch out for the robots, request user input from a human, and/or the like. Robots can use indicators to determine which floor the robots are at, which direction an elevator is going, and/or the like. Indicators can include signs indicating floor level, floor room, elevator lobby, room number, direction of elevator prior to arrival, elevator button indicating specific floors, and/or the like.

In some embodiments, robotic devices as described herein can be configured to execute navigation while avoiding collision with humans and equipment, inconvenience to hospital staff (e.g., blocking and/or contacting humans), blocking of elevator doors during opening and/or closing, and/or the like. In a hospital, robots can also be trained to navigate without damaging hospital infrastructure and/or equipment, without damaging themselves, without getting stuck, without inconveniencing hospital staff, and/or the like. Robots can also be trained to navigate efficiently while honoring navigation policies to arrive at destinations quicker.

In some embodiments, the problem-space for an elevator navigation system can be represented by a hierarchy of data objects that each contain information to be acted upon by various perception, navigation and/or manipulation sub-systems. The data can be interpreted and acted upon by a hierarchy of state machine and behavior trees. In some embodiments, the data can be captured in a representation that includes an environment of an elevator lobby and elevator cars divided into parts that map to robotic capabilities. For example, lobby areas can be represented as 2D polygons to map to localization and navigation. Up and down buttons to call the elevators can be represented as a group of obstacles, walls, and targets relative to a reference frame located at a point on a wall. Elevator cars can be represented as 2D polygons to map to localization and navigation. The floor buttons inside an elevator car can be represented as a group of obstacles, walls and targets relative to a frame located at a point on the wall. Elevator car doors can be represented by bounding boxes and a centroid that maps onto the perception sub-system. The components of the data representation can be hierarchically linked such that the robotic device can traverse the data to efficiently get to the next actionable component. For example, the lobby areas can link to up and down button panels, the lobby areas can link to elevator cars, the elevator cars can map to floor button panels, and the elevator cars can map to elevator doors.

In some embodiments, the data can be interpreted and acted upon by a robotic device employing a decision making system. The decision making system can include behavior trees for executing complex robotic tasks (e.g., pressing a call button, determining the correct elevator car has arrived, boarding the correct elevator car). The behavior trees can be embedded into a state machine, with a hybrid approach that allows for decision making at two levels: state machine (e.g., explicitly defined paths based on high-level discrete decisions), and behavior tree (e.g., overlapping paths and execution of a most efficient path to achieve a goal based on available knowledge and outcomes). In some embodiments, the decision making system can also include generating a behavior tree for pressing a call button, e.g., a behavior tree that supports the execution of an arm manipulation plan or trajectory. In some embodiments, the decision making system can also include determining that the correct elevator car has arrived and boarding the elevator car. In an example implementation, this can include a plurality of sub-trees that can be executed in parallel or sequentially. For example, the robotic device can execute sub-trees relating to perception, execution of certain tasks, etc. The perception information can be constantly or periodically updated, e.g., as the robotic device continues to capture information about its state and/or environment. The perception information can be used to determine which plans to execute and when to execute those plans, e.g., to board an elevator. In particular, the trees can ensure that the robotic device implements the most immediate action to board or performs actions that work toward boarding until it is able to board. In some embodiments, the robotic device may use hierarchal task networks (HTNs), planning domain description language (PDDL), or other planning approaches for navigating using an elevator, e.g., pressing a call button, determining when a target elevator has arrived, determining when to board the target elevator, etc. In some embodiments, information from one or more perception systems can be used together to determine whether an elevator has arrived, its direction, and when its doors are opened. In some embodiments, the decision making system can also include accounting for various failures. For example, both the state machine and the behavior trees can have routes and recovery behaviors that account for various failures associated with attempting complex robotic tasks in a dynamic, human environment.

In some embodiments, one or more perception systems (e.g., multi-modal and/or multi-sensory (such as audio and visual) systems that may employ one or more machine learning algorithms) can be used to capture and interpret data about the environment, the robotic device, etc. These perception systems can be combined with APIs for certain systems to add a level of certainty to the perceived systems and/or be used for self-supervised learning. For example, one perception system can be for elevator door detection. The representation of elevator doors can allow for an efficient method of determining their open or closed state such that the robot can navigate through the doors. In some embodiments, laser data can be used to determine if a sufficiently wide path exists through the bounding box that represents an elevator door. Another perception system can be for elevator arrival detection. The elevator arrival detection can analyze audio data (e.g., including the sound made by elevators) to indicate imminent arrival and direction of an elevator car. In some embodiments, a 1D convolutional network can be trained on collected audio data and used to determine elevator arrival. Yet another perceptive system can be for receiving and/or interpreting data from integrated systems such as, for example, an elevator monitoring system (e.g., Elevator APIs). These systems that integrate directly with elevator hardware can be laid over the perception systems to ensure the most correct information about the state of the elevators is fed to the decision making system.

Further details of these systems, data representations, and/or decisions are described with reference to the figures that follow.

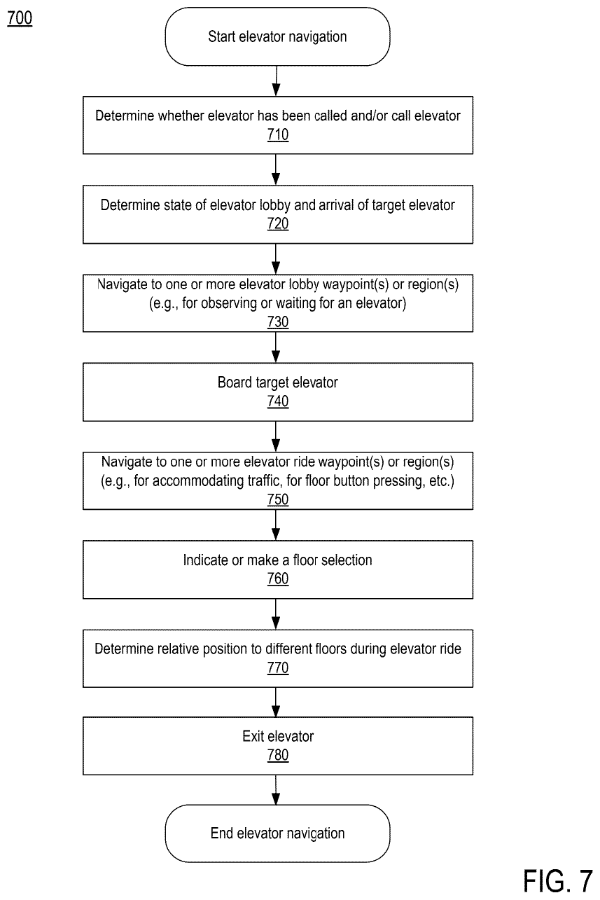

FIGS. 7-11 are flow diagrams illustrating a method 700 for elevator navigation, which can be performed by a system (e.g., system 100) including one or more robotic devices or robots, according to some embodiments. Method 700 can be performed by a single robotic device, such as any of the robotic devices described herein. Alternatively or additionally, method 700 can be performed sequentially or concurrently by multiple robotic devices and/or other compute devices, each performing a part of method 700. While specific steps, processes, or modules are depicted in FIGS. 7-11, it can be appreciated that may execute certain steps, processes, or modules in combination and/or bypass certain steps, processes, or modules, e.g., using end-to-end learning implemented using neural networks.

FIG. 7 provides a high-level flow of the method 700 for elevator navigation. When a robotic device arrives at an elevator lobby, the robotic device can be configured to execute a series of decisions between arriving at an elevator lobby and entering an elevator. In some implementations, a robotic device can be trained to execute decisions and/or actions based on contextual information. For instance, a robotic device can determine the state of an elevator such as, for example, an elevator is on its way, no elevator has been called yet, an elevator has left, etc. The robotic device can also determine the state of an elevator's doors such as, for example, opening, open, closing, closed, etc. The robotic device can also determine the probability of successfully navigating through open doors. For example, the elevator lobby and/or elevator car can include obstacles, and the robotic device can select, based on probability of success, specific paths in substantially real-time to navigate around obstacles, voice phrases for assistance or warning, and/or the like. The robotic device can also determine the state of the elevator car to navigate around obstacles in the elevator car and towards an open space for the robotic device to position itself in.

At 710, the robotic device can determine whether an elevator has been called and/or call an elevator. In some embodiments, a robotic device can be configured to communicate with elevator APIs and use the elevator APIs to determine an elevator state and/or if an elevator has been called (by another human or robotic device). Elevators that can support an API that can be used to call, track, and/or send elevator cars can have elevator APIs that a robotic device can call to substitute button pressing actions and/or elevator sensor processes. For example, the elevator APIs can be used to call the elevator without the robotic device physically traversing towards a call button panel to press a button for a desired direction and/or elevator.

In some embodiments, the robotic device can determine whether a button on the call button panel is already pressed, e.g., by a human or other robotic device. For example, the robotic device can rely on image data captured by a camera to determine whether an elevator call button is illuminated or otherwise indicates that it has already been pressed.

In some embodiments, the robotic device can be configured to move toward a call button panel to call an elevator. The robot can execute a path including one or more waypoints to move towards the elevator call button. In some implementations, the robotic device can be trained to recognize, negotiate, and/or interact with humans and obstacles. For example, the robot can voice phrases based on obstacles impeding the robot's path towards the call button panel and pressing the button. The robotic device can arrive at a predefined call button interact waypoint for the elevator lobby, perceive the elevator call button position or location, and press the correct button in the call button panel to call an elevator to travel in the desired direction (e.g., up or down). The robotic device can remain safe for other humans in the elevator lobby as the robotic device gets to the predefined call button interact waypoint and manipulates the elevator call button, e.g., by using safety bubble features to pause arm motion when someone enters the safety bubble. For example, as a robot interacts with a button, the robot can pause the motion of its arm when a human enters the safety bubble.

In some embodiments, the robotic device can use visual information such as fiducial markers to determine its environment when calling an elevator. In particular, a robotic device can use visual feedback from a camera or sensor of the robotic device to perceive information about the environment. In some instances, the robotic device can identify fiducial markers and, based on the known location of those fiducial markers relative to the call buttons of an elevator, execute one or more trajectories to successfully press an elevator call button. The fiducial marker can be pasted on the wall in the vicinity of the elevator call buttons and/or the location of each elevator call button. In some cases, the robotic device may also include a fiducial marker, e.g., on an arm of the robotic device, that can facilitate localizing a portion of the robotic device relative to the elevator call buttons. For example, the robotic device can use its fiducial detectors to determine the location of the wall fiducial marker and arm fiducial marker and execute a trajectory to position the arm fiducial marker relative to the wall fiducial marker to press the desired elevator call button, e.g., based on the stored relative position between the elevator call button and the wall fiducial marker as well as the location of the arm fiducial marker with respect to an end effector of the robotic arm. In some instances, the robotic device can also use camera sensors to perceive the pose or location of the elevator call button and the robotic arm without fiducial markers.

At 720, the robotic device can monitor the state of the elevator lobby and arrival of a target elevator (e.g., the desired elevator for boarding). The robotic device can be aware of the floor that it is positioned on, and monitor to determine when an elevator is arriving at that floor. In some embodiments, the robotic device can use indicators to determine which floor it is on, which direction an elevator is going, and/or when an elevator is arriving. Indicators can include signs indicating floor level, floor room, elevator lobby, room number, direction of elevator prior to arrival, and/or the like. In some embodiments, the robotic device can use audio data and/or other sensor data to determine when an elevator is arriving. For example, the robotic device can capture audio data associated with sounds in the elevator lobby and process that audio data with an algorithm (e.g., a trained CNN) to predict whether an elevator is arriving and/or whether an elevator that is arriving is going up or down. In some embodiments, the robotic device can communicate with an elevator management system (e.g. Elevator APIs) to identify when an elevator is arriving. For instance, the robotic device can use elevator APIs to determine whether an elevator is coming up or down, which floor the elevator is at, estimated time of arrival of the elevator, and/or the like. The robotic device can check using the elevator APIs to determine whether an elevator is arriving, and whether the elevator that is arriving is heading in the desired direction of the robotic device.

While the robotic device is in the elevator lobby, the robotic device can navigate to one or more positions or waypoints, at 730. For example, the robotic device may navigate to a waypoint or region in the elevator lobby to monitor the elevators and/or wait for the arrival of an elevator. When the elevator lobby includes multiple elevator doors, the robotic device can navigate to a waypoint or region that enables it to observe each elevator door in the elevator lobby (e.g., using its sensors). In some embodiments, the robotic device can move from the waypoint or region for observation to a second waypoint or region (e.g., a location near an elevator door) to wait for a specific elevator to arrive. The robotic device can be configured to, in response to determining that an elevator is arriving (e.g., based on sensor data and/or elevator APIs), move toward a position or region to prepare for boarding and/or entering the elevator once the elevator doors open. In elevator lobbies with multiple elevator doors, the robotic device can travel toward a position near the elevator door of the specific elevator that it intends to board prior to the arrival of that elevator.

In some implementations, the robotic device can move toward a waypoint with tolerance or navigate toward a region of space. In some cases, the robotic device can be configured to implement a degree of slack or flexibility in its navigation system to identify plans/trajectories that are more reliable or feasible. In some embodiments, the robotic device, in implementing such navigation, can account for the shape of the environment around the robotic device in the form of costmaps, potential fields, reciprocal velocity planners, geometric shapes derived through a machine learning inference, etc. In some embodiments, the robotic device can be informed by perception inputs (e.g., sensor data) that recognize objects in the environment and/or certain policies (e.g., don't stand next to a door). The robotic device can then select the most optimal (or a more optimal) position subject to these various conditions and execute a plan to navigate to that point.

As noted above, the robotic device can operate with a built-in safety zone or safety bubble such that the robotic device can engage in a safe position or stop operation when objects (e.g., humans) come into or overlap the safety zone. In some embodiments, the robotic device can be configured to mitigate complications such as, for example, impeding obstacles in path or destination of the robotic device, conflicting information (e.g., elevator arrives but elevator doors do not open, mismatched map data, etc.), interruptions/failures to actions (e.g., malfunctions within arms or body of the robotic device), and/or the like.

In some embodiments, the robotic device can move to one or more waypoints based on the state of the elevator lobby. For example, the robotic device can determine the level of occupancy of the elevator lobby and identify a waypoint or region that is clear (e.g., is not occupied) for the robotic device to occupy while it waits for the arrival of a target elevator. In some cases, if a lobby waypoint is occupied, the robotic device can select a different lobby waypoint, while accounting for constraints (e.g., obstacles). For example, when the robotic device determines that its original goal pose or waypoint {x,y,theta} is already occupied, the robotic device can select an alternate goal {x₂,y₂,theta₂} to navigate to. As the robotic device is navigating to the goal pose {x₂,y₂,theta₂}, if the goal pose becomes blocked or occupied, then the robotic device can select another goal {x₃,y₃,theta₃}. The various waypoints or poses can be predetermined based on semantic data. In some cases, where the path to a particular waypoint is blocked (e.g., due to an obstacle), the robotic device can select a different path to get to the lobby waypoint.

Once the target elevator arrives, at 740, the robotic device can take steps to board the target elevator. The robotic device can determine the state of the elevator upon arrival. In particular, the robotic device can determine whether the elevator doors are opening, open, closing, closed, and/or not working. The robotic device can also determine whether objects (e.g., humans) are blocking the entryway into the elevator. The robotic device can monitor for when there are no longer moving objects in an open doorway to navigate onto the elevator. The robotic device can also assess whether a particular elevator has enough space for the robot, e.g., due to current occupancy of the elevator car and/or number of individuals entering the elevator. The robotic device can autonomously enter the target elevator using perception inputs to determine when to enter the elevator, when to pause, when to yield, when to not enter an elevator (e.g., due to space constraints), and/or where to position itself for the elevator ride after entering.

In some embodiments, the robotic device can classify obstacles and/or objects that it perceives (e.g., using one or more sensors) to determine what plan or trajectory to execute. For example, the robotic device can classify objects into humans, beds, wheelchairs, and/or the like, and determine whether to board a particular elevator. The robotic device can also track dynamic objects or obstacles and determine an appropriate plan to execute. The robotic device can base its decision of which plan to execute based on one or more predefined criteria or policies. Such policies can be applied based on priority, e.g., a first policy taking priority over a second policy.

The state of the elevator can be constantly monitored by the robotic device when the robotic device is boarding the elevator (or determining whether to board the elevator). The robotic device can receive continuous inputs or information (e.g., from sensors, elevator APIs, users, etc.) about the elevator state as the robot navigates onto the elevator. The elevator state can include information that can be used by the robotic device to determine whether to board the elevator and/or when to board the elevator. For example, the robotic device can choose whether to pause, resume, or compute a different trajectory or waypoint depending on a measure of how boardable the elevator is (e.g., a likelihood of successful boarding of the elevator based on contextual information).

After the robotic device has boarded the elevator, the robotic device can navigate to an elevator ride waypoint or region, at 750. The elevator ride waypoint(s) can be safe areas or zones that the robotic device can occupy while riding the elevator. In embodiments, the robotic device can enter an elevator and move to a safety zone in the elevator at the earliest possible chance. The robotic device can reach an interaction waypoint to be able to press a floor button inside the elevator. If the floor buttons are blocked by another human or object, the robotic device can execute an audio to request, e.g., to a human, to press the desired floor button. In some cases, the robotic device can stay in an elevator spot that is easiest to exit.

The elevator ride waypoint(s) can be selected to accommodate traffic or occupancy (e.g., boarding and/or exiting traffic, positions of humans and/or other objects in the elevator, etc.). While moving to the ride waypoint, the robotic device can perceive information about the elevator car (e.g., using its sensors) and can select a new elevator ride waypoint if the original elevator ride waypoint becomes occupied. In some embodiments, the robotic device can also move to a different ride waypoint, e.g., if the first ride waypoint is obstructing or blocking a human, other robotic device, or other object. In some embodiments, the robotic device can navigate to a first ride waypoint for selecting a floor (e.g., by pressing a floor button), and to then navigate to a second ride waypoint for the remainder of the elevator ride. The second ride waypoint may be in an area that would not impede others from the floor selection panel. In some embodiments, the robotic device can also navigate to a third ride waypoint suitable for exiting the elevator as the robotic device determines that the elevator is approaching its desired floor. The various waypoints or poses can be pre-determined using semantic data and/or be determined live by optimizing one or more constraints (e.g., max distance from an elevator wall and/or humans or other objects in the elevator). In the case of optimization, the robotic device can continuously or repeatedly perceive information about its environment as it is entering and navigating within the elevator and has more visibility into the occupancy grid of the elevator, and apply this information to update its waypoint goal. If a waypoint goal becomes occupied, the robotic device can attempt to find a next optimal location, or if it is unable to find a next optimal location, the robotic device can fall back on using social cues and/or implement action to recover from failure.

In some embodiments, a human can interact with the robotic device during its ride. For example, a user can provide inputs to the robotic device (e.g., by speaking to the robotic device and/or manipulating a keyboard, joystick, or other input device). The user can request that the robotic device move to a new position or waypoint, exit the elevator at a floor, and/or engage in other actions. In some embodiments, the robotic device can use a behavior-tree based decision management system to choose the right action given the state of the robot, its observations, and/or other information provided to the robot (e.g., user inputs). The robotic device can be configured to determine and monitor its own state, such as, for example, where it is located in the elevator car, what floor the elevator car is at, state of the elevator door, etc. The robotic device can have a set of recovery behaviors if the robots fail to execute its intended actions in a scenario. Recovery behaviors can be designed to ensure the robotic device complies with the navigation boarding and/or exit policies, e.g., to not cause inconvenience to other individuals in the elevator (e.g., hospital employees or visitors).

The robotic device can be configured to indicate and/or make a floor selection, at 760. In some embodiments, the robotic device can navigate to a floor selection waypoint or region, which can be located around a floor button panel inside the target elevator. The robotic device can have stored (e.g., in onboard memory) or have access to a layout of the elevator to know where the floor button panel is located. Alternatively or additionally, the robotic device can use active scanning (e.g., using its sensors) to identify markers (e.g., fiducials, buttons, etc.) to determine the location and layout of the floor button panel and to make a floor selection. To press the floor button, the robotic device can execute a movement of its manipulating element (e.g., arm, end effector). In some cases, the target elevator can be crowded such that the robotic device cannot access the floor selection waypoint and/or make the floor selection. In such cases, the robotic device can perceive the crowded environment and execute pre-programmed audio files to request assistance in selecting the desired floor or to request humans to make way for the robotic device to approach the floor selection waypoint. In some cases, the robotic device can use elevator APIs to transmit a signal representing a selection of the desired button instead of physically pressing a floor button.

At 770, the robotic device can determine the position of the robotic device relative to the floors of a building. For instance, the robotic device can use various sensors to determine pressure, drifting, and/or velocity of the robotic device as the target elevator moves up or down. The robotic device can be configured with floor detection hardware, firmware, and/or software that can analyze one or more sensor inputs to estimate relative height and to apply that information to determine a relative position of the robotic device to the various floors of a building. In some embodiments, the robotic device can use sensor data at time of entry into an elevator as a reference value for its current floor, and to then determine a relative height and floor changes during the elevator ride. The robotic device can be configured to determine floors despite pressure changes and drifts over time. In some cases, the robotic device can use elevator APIs to determine which way the target elevator is going and/or what floor the target elevator arrives at or passes during the elevator ride.

At 780, the robotic device can exit the target elevator, e.g., on arrival at the desired floor. For instance, the robotic device can automatically and/or autonomously exit an elevator using perception inputs. The robotic device can detect that the elevator is arriving at a target floor and when the elevator doors open. Similar to entering an elevator, the robotic device can perform classification of objects into humans, beds, wheelchairs, and/or the like, and track dynamic obstacles. The robotic device can then select an appropriate plan to execute to exit the elevator, while honoring one or more policies specific to elevator exiting (e.g., not blocking the doorway, not colliding with another object, etc.). Similar to other policies described herein, the elevator exit policies can be ranked according to priority. In some embodiments, the robot can check using the elevator APIs to determine if that elevator is approaching the desired floor. The robotic device can, in response to determining that the elevator is approaching the desired floor, move to a waypoint or area for exiting the elevator.

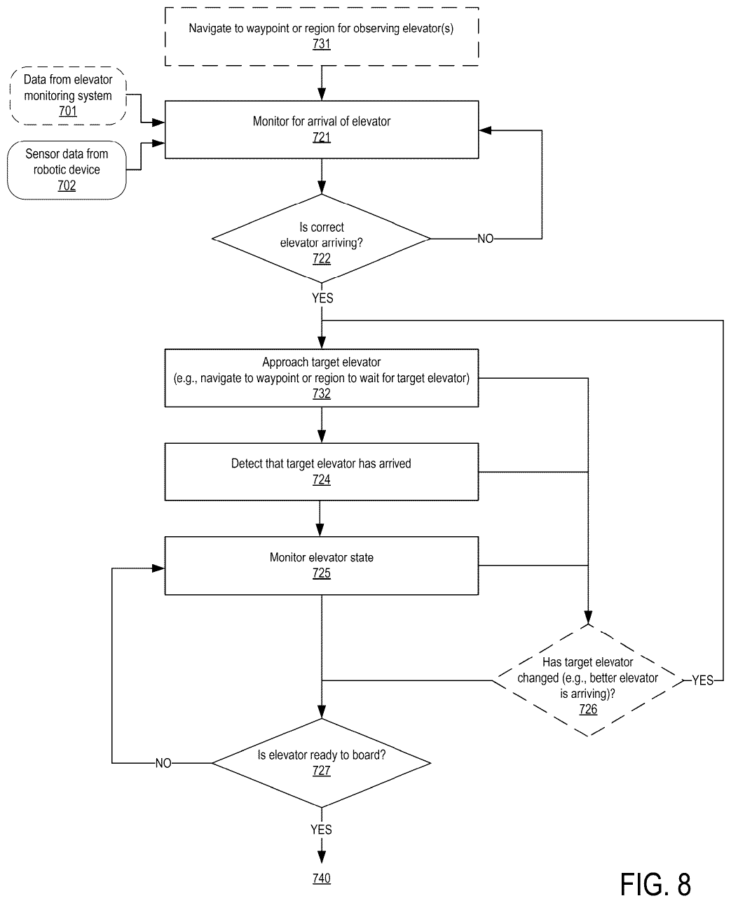

FIG. 8 provides a more detailed flow of lobby management and determining elevator state by a robotic device, according to embodiments. In particular, the steps depicted in FIG. 8 provide more details of steps 720-730 depicted in FIG. 7.

At 721, the robotic device can optionally navigate to one or more elevator lobby waypoint(s) or region(s). At 721, the robotic device can monitor an elevator lobby for the arrival of a target elevator. The robotic device can obtain data from an elevator monitoring system, at 701, and/or the robotic device can obtain sensor data, at 702. The data from the elevator monitoring system and/or the sensor data can be used by the robotic device to determine when the target elevator is arriving. For instance, the robotic device can use its sensors to capture information about the elevator lobby, including sounds, objects, elevator door locations, elevator lobby layout, and/or the like. In some embodiments, the robotic device can scan elevator floor indicators that indicate which floor an elevator is at, to infer the arrival of an elevator.

At 722, the robotic device can determine whether the target elevator (e.g., an elevator that is going in the direction required by the robotic device) is arriving at the elevator lobby. When the robotic device determines that the target elevator is arriving (722: YES), the robotic device can approach the target elevator, at 732. Approaching the target elevator can include navigating to a waypoint or region suitable for boarding the target elevator. The waypoint or region can be close to the door associated with the target elevator. The waypoint or region can also satisfy certain social requirements, e.g., enable potential humans and/or other objects to exit the arriving elevator. At 724, the robotic device can detect that the target elevator has arrived, e.g., based on data from an elevator monitoring system or API, sensor data, etc.

At 725, the robotic device can determine the state of the target elevator. Determining the state of the target elevator can include determining whether the elevator doors are closed or open, determining whether objects are moving through the doorway, determining an occupancy of the elevator (or space available in the elevator), and/or the like. The elevator state can be continuously or repeatedly updated while the robotic device is monitoring for boarding the elevator and while the robotic device is boarding the elevator. In other words, the robotic device can constantly monitor for information relevant to the elevator state while determining whether to board the elevator and/or boarding the elevator. Such information can allow the robotic device to determine whether to board the elevator and/or to continue boarding the elevator. For example, the robotic device can determine whether robot navigation should pause, resume, or be re-computed (e.g., whether a new plan should be executed or a new waypoint be selected), depending on elevator boardability conditions or other elevator state information.

Optionally, while the robotic device is monitoring the elevator lobby and/or target elevator, the robotic device can determine that the target elevator has changed, i.e., that a better or more suitable elevator is arriving, at 726. For instance, after an elevator is called, more than one elevator may arrive at the elevator lobby. In the case where another elevator is arriving or has arrived at the elevator lobby, the robotic device can determine if that other elevator is suitable for the robotic device to ride. For instance, another elevator that arrives faster or has fewer occupants (or more space) may be more suitable for the robotic device to board. If the target elevator should change (726: YES), then the robotic device can execute a new navigation path to approach the new target elevator, at 732.

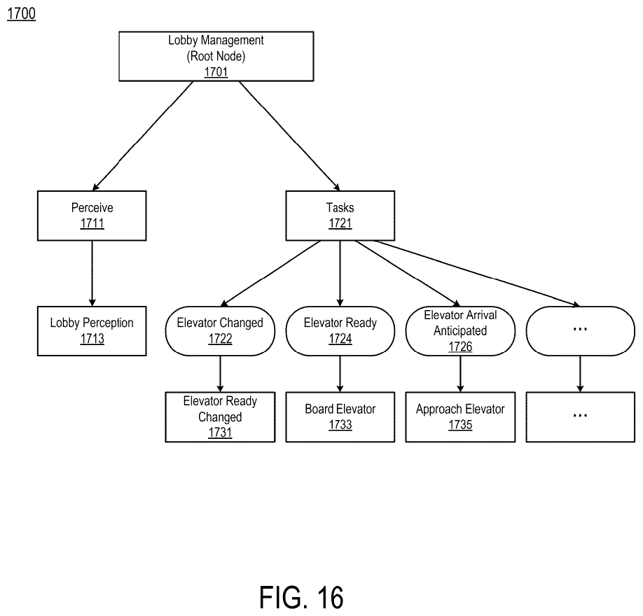

The robotic device can continue to monitor the state of the elevator lobby and the target elevator until it determines that the target elevator is ready to board. When the robotic device determines that the target elevator is ready to board, at 727, then the robotic device can board the target elevator, at 740. Further details of elevator lobby management and/or monitoring the elevator state are described with reference to FIGS. 16-18, described below.

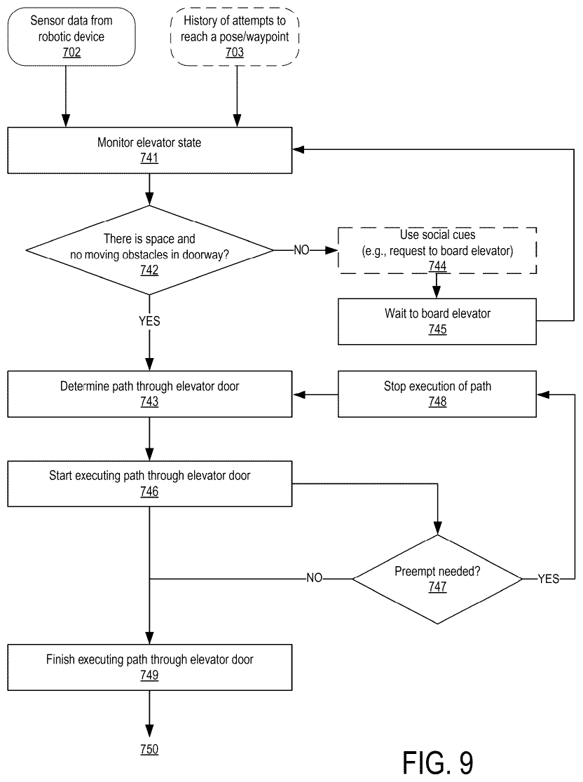

FIG. 9 provides a more detailed flow of boarding an elevator by a robotic device, according to embodiments. In particular, the steps depicted in FIG. 9 provide more details of step 740 depicted in FIG. 7. As depicted in FIG. 9, the robotic device can execute navigation to board an elevator.

The robotic device, in performing elevator entry, can be configured to autonomously enter an elevator using perception inputs. Based on perception inputs, the robotic device can determine which elevator to enter, when to pause, when to yield, and where to position itself for the ride after entering an elevator. While performing elevator entry, the robotic device can classify potential objects into human, bed, wheelchair etc. and track dynamic obstacles. The robotic device can select and execute its navigation boarding policies based on its perception inputs.

In some embodiments, the robotic device can perform elevator boarding while following one or more predefined policies, such as, for example, avoiding collision with humans, equipment, etc., avoiding causing inconvenience to humans, avoiding blocking potential paths of humans, avoiding damage to itself or other equipment, furniture, walls, etc., and/or the like.

At 741, the robotic device can monitor the elevator state of the target elevator, e.g., similar to 725 as described above. The robotic device can monitor occupancy of or space within the elevator car, objects moving through the elevator doorway (e.g., exiting humans or other objects, entering humans or other objects, etc.), and/or the like. In some embodiments, the robotic device can monitor the elevator state based on sensor data, at 702, and/or history of attempts to reach a pose and/or waypoint, at 703. For instance, the robotic device can use its sensors to perceive the elevator state such as, for example, occupancy, door open or closed, elevator car layout, and/or the like. The robotic device can also recall its history of attempts to reach a particular waypoint or region, e.g., for boarding the elevator, for standing within the elevator, etc. If the robotic device recalls an earlier failure to get to a particular waypoint, then the robotic device may adjust its action plan.

At 742, the robotic device can determine whether there is space and/or no obstacles in the doorway of the target elevator. If there is no space and/or there are obstacles, the robotic device can optionally implement one or more social cues. For example, if after a predetermined period of time, the robotic device still determines that the doorway is blocked, then the robotic device may use social cues to communicate to others around it. The robotic device can make use of semantic dialogues to request help from others (for example, “can you please call an elevator going up,” “can you make space for me to board the elevator,”, etc.), audio and/or visual cues to communicate intent (e.g. moving arms, displays on the touch screen, etc.), hazard cues to warn potential pedestrians of the robotic device's movement, failure state cues and keep bystanders informed, and/or the like. In some embodiments, the robotic device can use a lighted headband and/or eye states to subtly indicate its state, a change of that state, and/or an intent. In some embodiments, the robotic device can use audio cues to indicate types of failure. In some embodiments, social scenarios can include seeking help from people in the building, signaling to people who may not have visibility of the robotic device to avoid unsafe navigation, acknowledging people around the robotic device, and/or the like. Seeking help can include requesting for direct help (e.g., pushing a button), getting out of a robotic device's path, and/or the like. Signaling to people who may not have visibility of the robotic device can include transmitting preventative communication when the robotic device is not visible to potential pedestrians. Acknowledging people around the robotic device can include interacting with people, execute audio containing socially appropriate language to make people feel more comfortable, happier, and/or forgiving as to the robotic device's presence or behavior.

The robotic device can then continue to wait to board the target elevator, at 745, monitor the state of the elevator, at 741, and determine when it can board the elevator, at 742.

If there is space and no obstacles in the elevator doorway (742: YES), the robotic device can determine a path or plan through the elevator door. The path can include executing navigation to an elevator ride waypoint inside the target elevator. In some embodiments, the robotic device can select a navigation plan from a cache (e.g., a plurality of predetermined plans for navigating through an elevator doorway). The robotic device can select the plan based on a current pose or position of the robotic device relative to the doorway of the elevator (or other physical feature). In some embodiments, the robotic device can live plan (e.g., plan at substantially real time such as, for example, within seconds) a trajectory onto the elevator. At 746, the robotic device can start executing the plan through the elevator door.

While executing the plan, the robotic device can check if any conditions or changes require preemption, e.g., pausing of execution and/or replanning of execution. If the robotic device determines that preempt is required (747: YES), the robotic device can stop execution of the plan, at 748, and re-determine the path through the elevator door. If no preempt is required (747: NO), the robotic device can finish executing the path through the elevator door, at 749. In some embodiments, the robotic device can navigate to a waypoint or pose or any of a plurality of waypoints or poses while receiving as perception inputs: (a) the state of the robotic device in space and in velocity, and (b) the recent history of previous attempts to reach that waypoint or pose.

In some embodiments, the robotic device can implement sanity checks, e.g., to determine whether a preempt may be required in advance. The robotic device can ensure that it identifies points of failure in a malformed plan, such as, for example, points that the robotic device cannot execute. In some embodiments, for a given timestep, the robotic device can evaluate the local trajectory (e.g., the plan for the next few meters) and apply a sanity check to ensure that the path is kinematically followable or feasible. Failed checks result in the robotic device declaring that position as infeasible. Infeasible points, either from collisions or from kinematic issues with the path, are marked as points where the robotic device has to stop. The robotic device can then determine a different plan or path to execute.

As noted above, the robotic device can be configured to navigate to a waypoint with a degree of tolerance, i.e., navigate to a region of space vs. a specific waypoint. As such, when boarding the elevator, the robotic device can be configured to navigate to a region of space within the elevator, e.g., for riding the elevator. In some embodiments, a user may be allowed to specify a waypoint or pose that the robotic device can drive to with a predetermined amount of tolerance.

In some embodiments, the robotic device may move its arm and/or other components into a predetermined pose prior to boarding the elevator. The predetermined pose may be a tuck pose that is designed for safe navigation. The predetermined pose may also be suitable for small spaces inside of an elevator, e.g., in a crowded elevator. The predetermined pose may also allow the robotic device to easily manipulate its arm and/or end effector to press a floor button or perform other actions within an elevator.

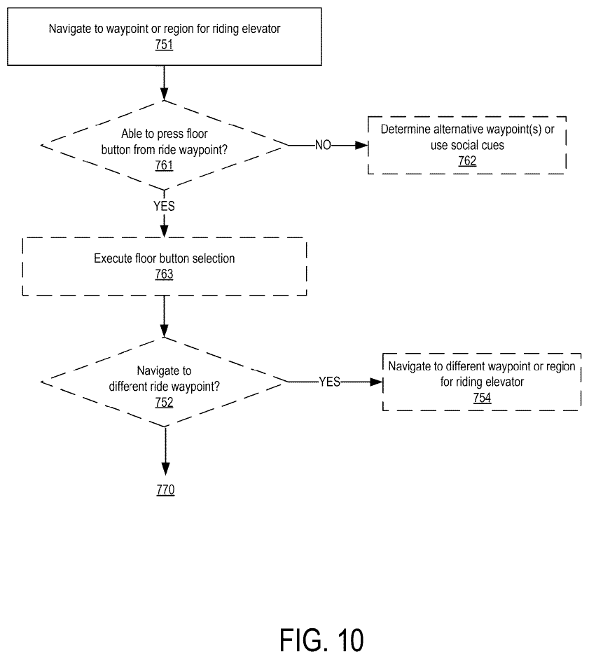

FIG. 10 provides a more detailed flow of elevator ride management, according to embodiments. The steps depicted in FIG. 10 provide more details of steps 750-760 depicted in FIG. 7.

Ride management can begin when the robotic device has completed its navigation into the elevator. During an elevator ride, a user (e.g., a hospital employee) can request that the robotic device exit the elevator at any floor. The robotic device can use a behavior tree-based decision management system to choose an action to execute given the state of the robotic device and one or more observations. The robotic device can deduce the state of the robotic device from different components, such as, for example, knowledge of the current floor from its floor detection system, location of the robotic device from its navigation system, feasibility of reaching the waypoint to push the floor button from its costmaps and perception system, state of the elevator door from the door detection perception system, etc. In some embodiments, the robotic device is designed to have a set of recovery behaviors if the robotic device fails to execute its selected action in each scenario. These recovery behaviors are designed to ensure that the robotic device honors the policies described above and does not cause inconvenience to users (e.g., hospital employees or visitors).

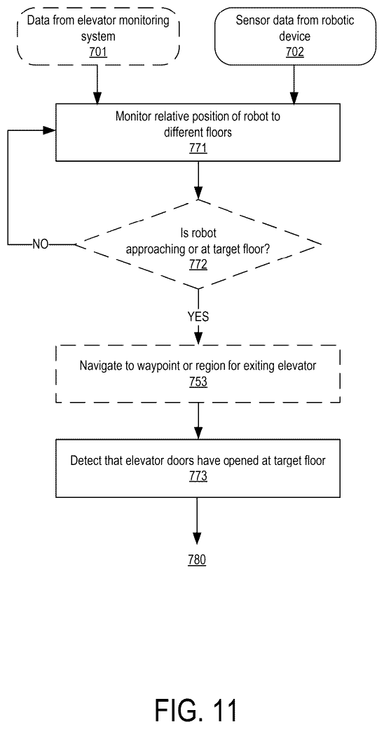

In some embodiments, ride management can include determining an elevator floor state. The robotic device can monitor the elevator floor state based on inputs from one or more sensors and/or analysis thereof. The robotic device can use the determined floor state to inform other actions, e.g., when to prepare to exit the elevator, when to recover from failure during an elevator ride and to exit at an intermediate floor, etc. Further details of determining an elevator floor state are described with reference to FIG. 11.

In some embodiments, ride management can also include handling disembark requests. For example, the robotic device can be configured to receive inputs from users and to act based on those inputs. In an embodiment, a user may instruct a robotic device to disembark the elevator early, and the robotic device can exit the elevator at an intermediate floor.

In some embodiments, ride management can also include recovery from failure. For example, the robotic device can be configured to implement one or more recovery behaviors, e.g., based on a current state of the robotic device and/or environment. The robotic device can select a recovery path when there are failures due to robot process failures, environmental factors such as a crowd not allowing the robotic device to exit at its destination floor, and/or the like.

In an example implementation, the robotic device can use data from sensors including one or more 2D lidar sensors and/or RGBD cameras to monitor occupancy within an elevator. The robotic device can merge the occupancy data from the sensors to resolve conflicting data. For example, if a first sensor captures data that indicates that no obstacle is present at a first location but a second sensor captures data that indicates that there is an obstacle at the first location, then the robotic device can determine whether there is an obstacle based on a ranking applied to the sensor data, whether certain sensor data may be faulty, etc.

At 751, the robotic device can navigate to a waypoint or region for riding the elevator. In some embodiments, the robotic device can stay at this waypoint or region, e.g., until the robotic device arrives at its destination floor and exits the elevator. Alternatively, in some embodiments, the robotic device can navigate to one or more additional waypoint(s) or region(s).

Optionally, at 761, the robotic device can check if it can reach a floor button panel in the elevator. If the robotic device is unable to reach the floor button panel, the robotic device can determine an alternative waypoint for accessing the floor button panel or employ social cues, at 762. Social cues can include asking for assistance from humans or other robotic devices near the robotic device. For example, the robotic device can request for assistance from a human or other robotic device to select a floor. If the robotic device is able to reach the floor button panel, the robotic device can execute a floor button selection, at 763.

In some embodiments, the robotic device may implement an elevator tuck selection framework. During a training phase, the robotic device may generate a workspace and reachability maps for each of a plurality of candidate elevator tuck poses and manipulation strategies. Then during execution, the robotic device can, given a goal button pose, select an elevator tuck pose that maximizes task success (e.g., maximizes reachability area within the elevator). The robotic device can then use the selected pose and manipulation strategy to select an optimal position or location for the base of the robotic device to be in for the elevator tuck pose. The robotic device can then navigate to this position (e.g., waypoint) in the elevator. Once in position, the robotic device can execute arm manipulation to press an elevator floor button. While executing the arm manipulation, the robotic device can capture information about itself, its surrounding environment, the objects within that environment, and/or the elevator to determine whether to change or abort the arm manipulation.

In some embodiments, the robotic device may have multiple end effectors, e.g., to account for the variability of different elevators. For example, the robotic device may have an arm that can support multiple end effectors, which can allow for different button pressing capabilities for different button and panel configurations inside an elevator car. In an example implementation, the robotic device can have an end effector protruding radially from its final arm link and one protruding axially that results in a larger robotic base reachability footprint in an elevator car. When the robotic device supports multiple end effectors, the robotic device can be trained with the different grippers and/or end effectors. In some embodiments, the robotic device may be configured to transfer manipulations taught on an old gripper and/or end effector to a new gripper and/or end effector without requiring the robotic device to be retaught entirely on the new gripper and/or end effector.

In some embodiments, the robotic device may not need to select a floor via a floor button panel, and therefore 761 may be omitted. For instance, the robotic device may be able to communicate with an elevator API to have the elevator go to that floor. In some embodiments, the robotic device may have needed to select the floor prior to boarding the elevator, e.g., in cases where floor selection is done in the elevator lobby. In such embodiments, 761-763 may be performed by the robotic device in the elevator lobby.

Optionally, at 752, the robotic device can determine whether to move to a different ride waypoint or region. For example, the robotic device may determine to navigate to a different ride waypoint after selecting a floor to avoid blocking the floor selection panel. The robotic device may also determine to navigate to a different ride waypoint as the robotic device determines that it is nearing or approaching its desired floor. The robotic device may also determine to move to a different ride waypoint if less or more space is available in the elevator, if people need to exit the elevator, etc. If the robotic device determines to navigate to a different ride waypoint or region (752: YES), the robotic device can navigate to that different ride waypoint or region, at 754.

FIG. 11 provides a more detailed flow of conducting floor detection during an elevator ride by a robotic device, according to embodiments. In particular, the steps depicted in FIG. 11 provide more details of step 770 depicted in FIG. 7.

At 771, the robotic device can detect or monitor a relative position of the robotic device to the different floors of a building (e.g., a hospital). The robotic device can estimate a relative height, which can be used to determine the robotic device's relative position to the various floors of the building. The robotic device can obtain data from an elevator monitoring system, at 701, and/or the robotic device can obtain sensor data, at 702. In some embodiments, the robotic device can use sensor data at the time of entry into an elevator as a reference for its current floor, and then use that to determine a relative height of the robotic device and floor changes during its elevator ride. This technique can allow the robotic device to accurately determine its floor despite pressure changes and drifts in sensor readings over time. In some embodiments, the robotic device can use its sensors to perceive an environment of the elevator, such as, for example, an elevator floor indicator, and use that information to detect its floor. In some embodiments, the robotic device can receive information from an elevator API and use that information to determine its floor.

In an example implementation, the robotic device can use one or more of a camera, laser data, a barometer, an inertial measurement unit (IMU), an accelerometer, etc. to detect its floor. The robotic device can receive acceleration data, e.g., from the IMU and/or accelerometer, which can be used to provide vertical odometry data. The robotic device can receive pressure readings from the barometer, which can be used to determine a height, e.g., by being interpolated over calibration data associated with known heights. The robotic device can combine (e.g., fuse) these outputs to provide an estimate of the relative height of the robotic device and its floor. In some embodiments, certain constraints can be applied to the determined height or floor, e.g., to avoid unrealistic jumps or changes in height.

Optionally, at 772, the robotic device can check if the elevator is approaching its target or desired floor. When the robotic device is approaching the target floor (772: YES), the robotic device can optionally navigate to a waypoint that is more optimal or suited for exiting the elevator, at 753. The robotic device can detect that the elevator doors have opened at the target floor, at 773, and the robotic device can proceed to exit the elevator, at 780.

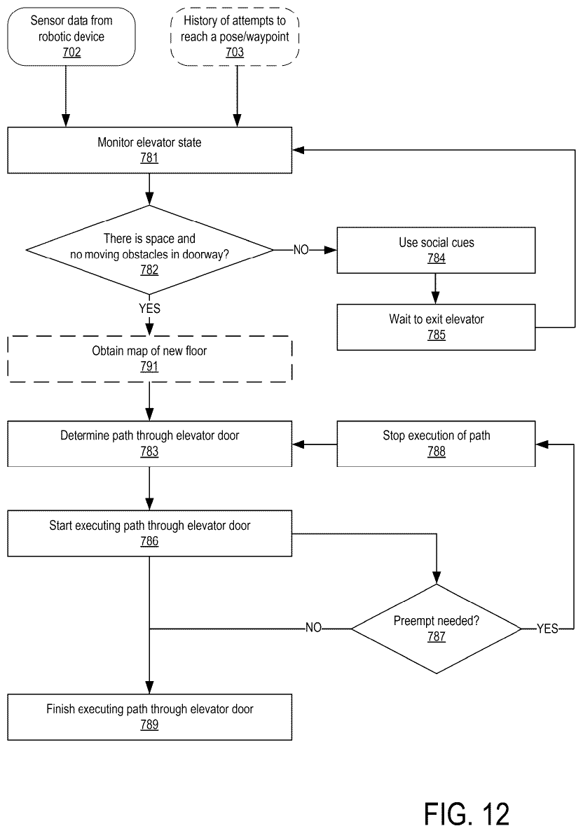

FIG. 12 provides a more detailed flow of exiting an elevator by a robotic device, according to embodiments. In particular, the steps depicted in FIG. 9 provide more details of step 780 depicted in FIG. 7.

The robotic device, in performing elevator exit, can be configured to autonomously exit an elevator using perception inputs, e.g., to determine the elevator state, occupancy around the robotic device and the elevator door, etc. Similar to elevator entry, as described above with respect to FIG. 9, the robotic device during elevator exit can actively scan and/or perceive information about its environment and classify objects in the environment into human, bed, wheelchair etc. and track the movement of dynamic obstacles. The robotic device can use this information to select and execute its navigation exit policies, e.g., similar to the ones described above with respect to elevator entry.

At 781, the robotic device can monitor the state of the elevator that it is in. This can be similar to 741, as described above with respect to FIG. 9. In some embodiments, the robotic device can monitor the elevator state based on sensor data, at 702, and/or history of attempts to reach a pose and/or waypoint, at 703. The robotic device can monitor occupancy of or space within the elevator car, objects moving through the elevator doorway (e.g., exiting humans or other objects, entering humans or other objects, etc.), and/or the like. The robotic device can also recall its history of attempts to reach a particular waypoint or region, e.g., for exiting the elevator. If the robotic device recalls an earlier failure to get to a particular waypoint, then the robotic device may adjust its action plan.

At 782, the robotic device can determine whether there is space and/or no obstacles in the doorway of the elevator. This can be similar to 742, as described above with respect to FIG. 9. If there is no space and/or there are moving obstacles, the robotic device can optionally use social cues to request humans to allow the robotic device to exit, at 784. This can be similar to 744, as described above with respect to FIG. 9. At 785, the robotic device can wait to exit the elevator after implementing the social cues. This can be similar to 745, as described above with respect to FIG. 9. The robotic device can continue monitoring elevator state, at 781, to determine when the exit path is clear.

Optionally, at 791, the robotic device can obtain a map of the new floor. For example, the robotic device may access and/or obtain a map of the floor that it has arrived at. In some embodiments, the robotic device may obtain the map prior to taking the elevator to the new floor, e.g., while it is still in the elevator lobby waiting to board an elevator. In some embodiments, the robotic device may already have a stored copy of the map of the new floor. For example, the robotic device may have a map stored of all of the floors of a building (or a subset of the floors of a building, e.g., that the robotic device is most likely to navigate to). As such, in some embodiments, the robotic device does not need to receive a map of the new floor.

At 783, the robotic device can determine a path through the elevator door, e.g., based on its current pose or waypoint, the map of the new floor, the waypoint on the new floor that the robotic device plans to navigate to, etc. This can be similar to 743, as described above with respect to FIG. 9. The robotic device can execute navigation to reach a goal waypoint on the new floor, thereby exiting the elevator onto the new floor. In some embodiments, the robotic device can select a navigation from a cache of pre-planned trajectories. In some embodiments, the robotic device can perform live planning to generate a trajectory for exiting the elevator.

At 786, the robotic device can start executing the path through the elevator doors. This can be similar to 746, as described above with respect to FIG. 9. While executing the plan, the robotic device can check if any conditions or changes require preemption, e.g., pausing of execution and/or replanning of execution. If the robotic device determines that preempt is required (787: YES), the robotic device can stop execution of the plan, at 788, and re-determine the path through the elevator door. If no preempt is required (787: NO), the robotic device can finish executing the path through the elevator door, at 789. This can be similar to 747-749, as described above with respect to FIG. 9.

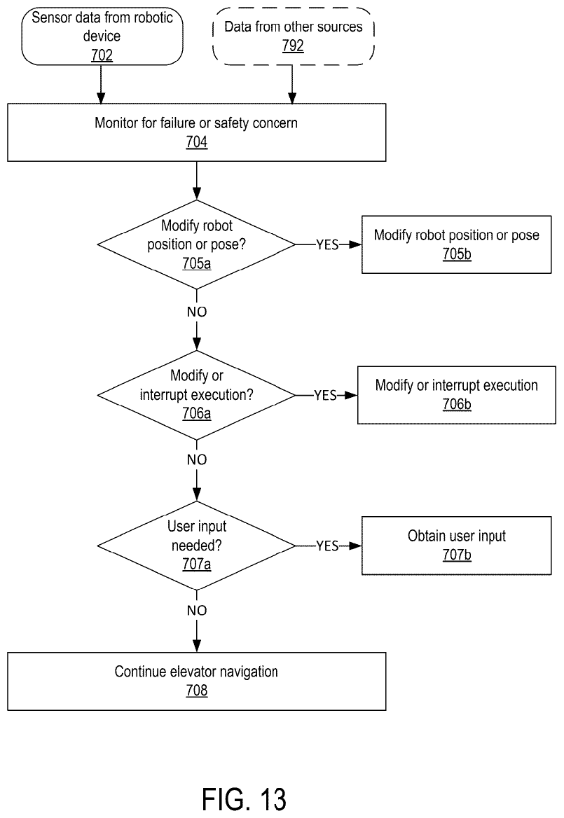

FIG. 13 is a flow diagram illustrating a method of replanning or determining a new goal by a robotic device, according to some embodiments. The method depicted in FIG. 13 can be performed continuously and/or periodically by the robotic device, e.g., when the robotic device is navigating using an elevator. As such, the method described in FIG. 13 may cause the robotic device to terminate, pause, delay, or otherwise adjust any of the steps described with reference to FIGS. 7-12.

At 704, the robotic device can monitor for failure, a safety concern, or other condition and/or event. For example, the robotic device can monitor for one or more conditions associated with a predefined policy (e.g., an elevator boarding policy, an elevator exit policy, an elevator ride policy, a lobby management policy, etc.). In some embodiments, a condition or event can be whether an object has entered the robotic device's safety bubble. The robotic device can perform active scanning and/or perception of its environment, e.g., by obtaining sensor data from one or more of its sensors, at 702, and/or data from other sources (e.g., an elevator API, an elevator monitoring system, a hospital system, etc.), at 792.

At 705a, the robotic device can determine whether it needs to modify its position or pose. If the robotic device determines that it needs to modify its position or pose (e.g., due to detecting a condition and/or event as described above), the robotic device can modify its position or pose, at 705b. At 706a, the robotic device can determine whether it needs to modify or interrupt its execution of a plan or trajectory. If the robotic device determines that it needs to modify or interrupt its execution, the robotic device can modify or interrupt its execution, at 706b. At 707a, the robotic device can determine whether it requires user input. For example, the robotic device may have encountered an obstacle or issue that it cannot autonomously address (e.g., a failure that the robotic device cannot autonomously recover from). If user input is required, the robotic device can obtain user input, at 707b. If no condition or event exists that requires replanning and/or user input (i.e., 705a, 706a, 707a: NO), then the robotic device can continue its operation as planned.

In some embodiments, a robotic device can be trained to perform floor detection (e.g., which floor is the robotic device near or at). For example, a robotic device can train by capturing sensor data (e.g., data while the robotic device is riding the elevator) relative to reference data (e.g., data at the starting floor of the robotic device). Such data can then be used to determine a relative height of the robotic device, which can then be correlated to a change in floor. As another example, a robotic device can implement a trained machine learning algorithm (e.g., trained on pressure data, temperature data, IMU data, camera images, etc.) to detect the floor that it is closest to.

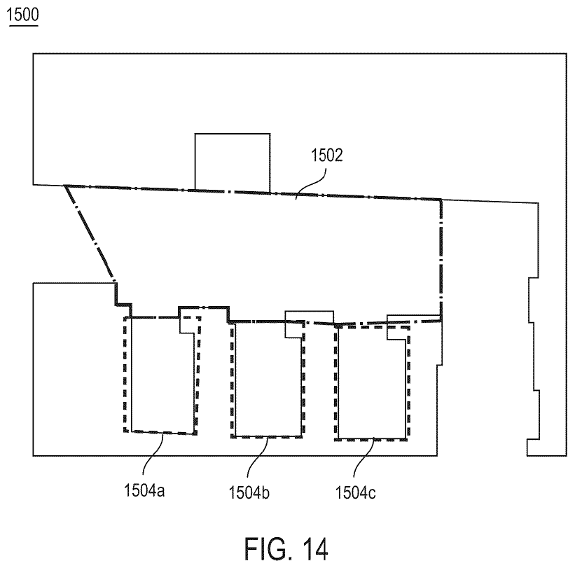

FIG. 14 is an illustrative representation of an elevator map 1500 as interpreted by a robotic device, according to some embodiments. Elevator map 1500 can depict a top-down view of an elevator lobby 1502 that can include doors to multiple elevators 1504a, 1504b, 1504c. In particular, the elevator lobby 1502 can include three elevator doors to three elevators 1504a, 1504b, 1504c. A robotic device having this map can appreciate that there are three doors through which it can board one of the three elevators 1504a, 1504b, 1504c. In the map, the elevator lobby 1502 can be marked with a first bounding box, and the elevator locations can each be marked with second, third, and fourth bounding box, respectively. During lobby management, as described above, the robotic device can use the map to determine a pose or waypoint to navigate to for boarding one of the three elevators 1504a, 1504b, 1504c, e.g., based on detecting the elevator arrival.

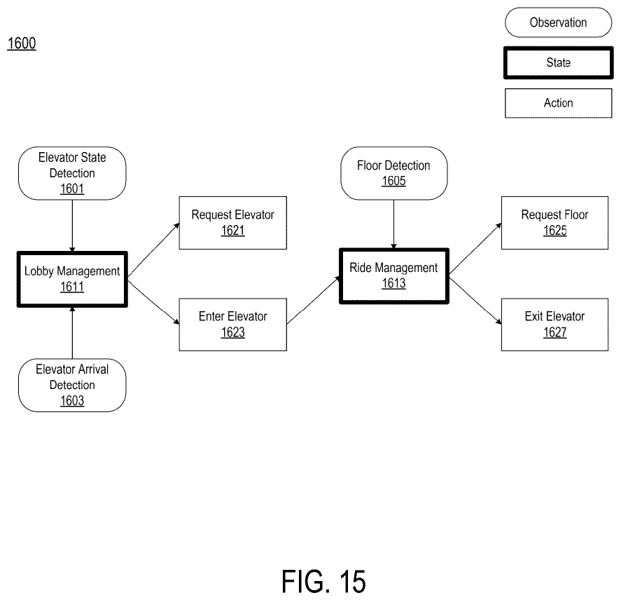

FIG. 15 depicts the architecture of a state machine flow 1600 for elevator navigation by a robotic device, according to some embodiments. The state machine flow 1600 includes elements associated with an observation, a state, and/or an action. The state elements define a state of the robotic device. The observation elements can be or include processes and/or modules that the robotic device can execute to observe and/or perceive data. The action elements can be or include processes and/or modules in which the robotic device performs an action.

Similar to that described above with reference to FIGS. 8 and 9 on lobby management, the robotic device in the lobby management state 1611 can receive data from elevator state detection perception system 1601 and elevator arrival detection perception system 1603. The robotic device in the lobby management state 1611 can also perform actions including, for example, requesting an elevator 1621 and/or entering an elevator 1623.

Once the robotic device has entered the elevator, the robotic device can operate in a ride management state 1613. Similar to that described above with reference to FIGS. 10-12, in the ride management state 1613, the robotic device can receive data from floor detection perception system 1605, e.g., to determine which floor the robotic device is at while the elevator moves. The robotic device in the ride management state 1613 can perform actions such as, for example, requesting a floor 1625 to cause the elevator to arrive at a desired floor and exiting the elevator 1627.

FIG. 16 depicts the architecture of a behavior tree 1700 for lobby management by a robotic device, according to some embodiments. The behavior three 1700 can include one or more processes, modules, and/or functions that the robotic device can execute during lobby management. The behavior tree 1700 can include a root node 1701. From the root note 1700, two child nodes can be performed in parallel or sequentially, or different parts of the nodes can be performed in concurrently and/or sequentially. For example, the perceive node 1711 and the tasks node 1721 can be executed in parallel, or the tasks node 1721 can be executed after executing the perceive node 1711. In some embodiments, the perceive node 1711 and the tasks node 1721 can be executed continuously or periodically, e.g., when the robotic device is in the lobby.

The perceive node 1711 can refer to a task of perceiving, observing, and/or scanning for contextual information. In particular, the perceive node 1711 can include executing lobby perception 1713. Lobby perception 1713 can refer to perceiving or sensing information about the elevator lobby (e.g., whether an elevator has been called, whether an elevator is arriving, occupancy of elevator lobby, etc.). The information obtained at the perceive node 1711 can update the robotic device's representation of the elevator lobby environment and inform one or more decisions or actions that the robotic device may engage in, e.g., under the tasks node 1721.

The tasks node 1721 can include multiple child nodes that can be organized from left to right in order of traversal. These child nodes can include, for example, an elevator changed node 1722, elevator ready node 1724, an elevator arrival anticipated node 1726, and/or one or more additional nodes. The child nodes under the tasks node 1721 can be executed according to a predefined ranking or order. Each node 1722, 1724, 1726, and 1724 can be associated with a condition, state, or event that can be checked based on the information obtained from lobby perception 1713. The elevator changed node 1722, when running, determines whether the best elevator for boarding has changed, and if it has, then it traverses to elevator ready changed node 1731 to execute one or more actions associated with the elevator changing. The elevator ready node 1724, when running, determines whether a target elevator is ready (e.g., that the elevator has arrived and its doors are clear for boarding), and if it is ready, then it traverses to a board elevator node 1733 to board the target elevator. The elevator arrival anticipated node 1725, if running, determines whether a target elevator is arriving, and if the elevator is arriving, then it traverses an approach elevator node 1735 to approach the arriving elevator. In some embodiments, the robotic device can execute one or more additional tasks, e.g., observe elevator lobby, move to avoid obstacle(s) or to avoid blocking others, etc.

In some embodiments, behavior trees can be embedded into state machines, which can allow for decision making at two levels. A state machine can explicitly define paths based on high-level discrete decisions. High-level discrete decisions can describe an overall task objective of a state machine. For example, deciding whether to go press a button or wait for an elevator can be a high-level decision and involve more complex instructions to execute. Deciding when to stop the movement of a robotic device's arm can be a low-level, discrete decision, as such decision may not need to be expanded on further.

In some embodiments, behavior trees can have multiple overlapping paths in providing a most efficient path to achieve a goal. Paths can be overlapping when, for example, multiple different traversals of the tree can reach the same goal in different ways using the same nodes. In some cases, the most efficient path can be determined by prioritizing actions that take a robotic device directly to a goal (e.g., waypoint), and falling back to more complicated actions when the actions toward the goal fails. In some cases, the behavior tree can be a way to organize back-up plans. In some cases, the robotic device can start at a simplest path towards a goal, and at each point where something may go wrong (e.g., either an action fails or the circumstances do not permit an action), the robotic device can branch, and execute alternative actions created and/or trained to execute during a setup phase.

In some embodiments, the behavior tree 1700 can be interpreted as two trees, e.g., one for perception (e.g., perceive node 1711) and one for tasks (e.g., tasks node 1721). Each of the perception and the tasks nodes can be considered its own behavior tree. As such, the perception tree (with the perceive node 1711 being the root node) and the tasks tree (with the tasks node 1721 being the root node) can be executed and/or performed in parallel or sequentially (or portions thereof can be performed in parallel or sequentially). The perceive node 1721 can determine state of an elevator lobby using, for example, audio cues and a laser scan of the elevator lobby. In some cases, the robotic device can integrate visual cues to perceive the elevator lobby. The tasks node 1721 can be responsible for controlling actions of the robotic device. In some embodiments, the information from the perceive node 1711 can feed into the tasks node 1721 to ensure that the latter is operating on the latest information obtained by the former.

In some embodiments, the behavior tree 1700 can aim to board the robotic device onto an elevator as soon as possible. Boarding as soon as possible can include the robotic device observing both elevators from a central spot. When the correct one is arriving, the robotic device positions itself to board, without blocking the doors or humans exiting the arrived elevator. When the doors are open, the navigation system tries to determine if the elevator can be boarded (e.g., there is space, the doors are clear of moving obstacles, etc.), as well as where the robot should navigate to within the elevator (e.g., goal waypoint). In other words, the behavior tree 1700 can ensure the most immediate action is taken to board, or performs actions that work towards boarding until the robotic device is able to. It is to be understood that training for the robotic device to navigate and/or execute actions can be done prior to deploying the robotic device, such that, for example, the elevator lobby is represented in data. The locations of the elevators, where their doors are, where the call button is, where a good spot to observe the elevators from, where a sensible spot to approach the elevators from, etc. can each be trained prior to deploying the robotic device for autonomous elevator navigation.

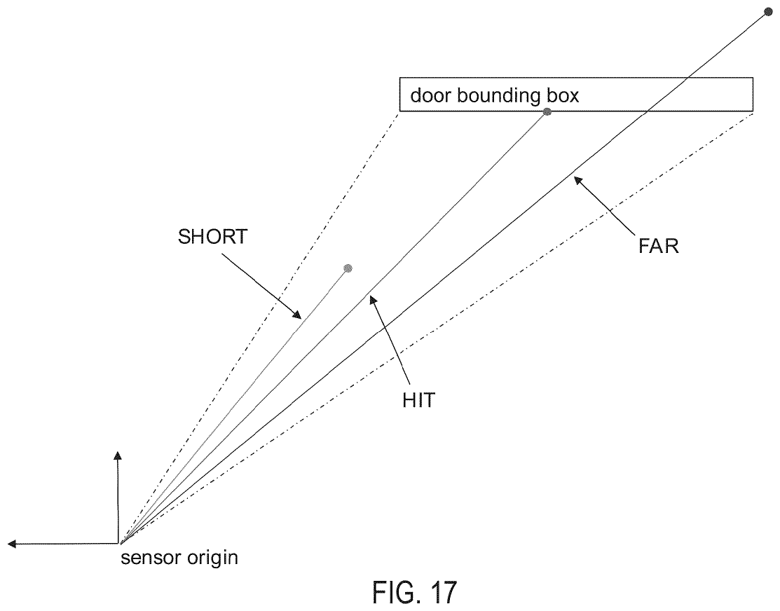

In some embodiments, detecting whether a door of an elevator is open or closed can be based on percentages of different beams. FIG. 17 illustrates different possible light beams that can be associated with a door detection analysis, according to some embodiments. As shown in FIG. 17, a sensor of a robotic device (e.g., a lidar sensor) located at a sensor origin can transmit signals (e.g., light or laser beams) toward an elevator door represented as a bounding box. The door bounding box can represent a space or region that an elevator door is expected to occupy, or a space or region separating an elevator lobby and an elevator. The signals can be configured to aim at a door bounding box and return back to the sensor origin to determine classification of the signals as well as classification of an elevator door (e.g., door state).

In some embodiments, the door bounding box can be converted into an angle range and a distance from the sensor origin. The robotic device, based on this information, can then determine whether one or more beams that originate at the sensor origin are hit, short, or miss beams. Short beams are those that stop short of a minimum threshold distance, hit beams are those that stop at the expected door distance (i.e., at the door bounding box), and miss beams are those that go further than the door distance.

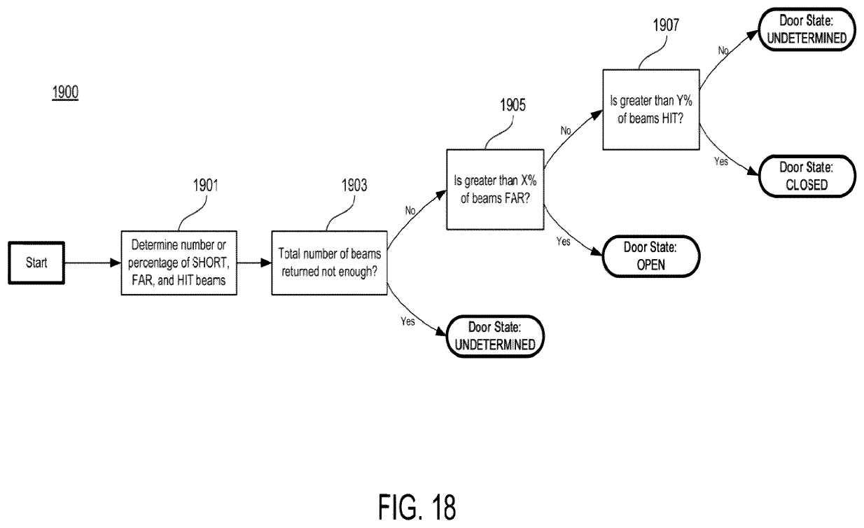

FIG. 18 illustrates a decision tree 1900 for determining an elevator door state (e.g., open or closed) by a robotic device, according to some embodiments. The decision tree 1900 can be implemented by any of the robotic devices or other compute devices described herein. The decision tree 1900 can include determining elevator door state using sensor data such as the beam information described with respect to FIG. 17. The decision tree 1900 can include, at 1901, determining a number or percentage of short, far, and hit beams. The determination or classification of whether an elevator door is open, closed, or undetermined/unknown can then be based on, for example, the total number of beams returned, and a fraction or percentage of the beams that are short, far, and hit beams.

At 1903, if the total number of beams returned is not enough (e.g., less than a predetermined number or less than a predetermined percentage of a total number of beams), then the door state is undetermined/unknown. If the total number of beams returned is enough, then, at 1905, if the percentage of beams that are far (i.e., extend a distance greater than the door bounding box) is greater than a predetermined percentage X%, the door state is open. If the percentage of beams that are FAR is less than X%, then, at 1907, if the percentage of beans that are hit (i.e., extend the distance of the door bounding box) is greater than a predetermined percentage Y%, the door state is closed. Otherwise, the door state is undetermined/unknown. It can be appreciated that other door classification schemes can also be used to determine the door state.

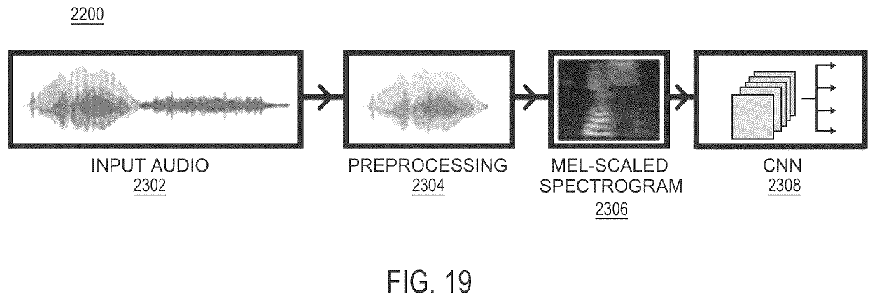

In some embodiments, elevator arrival can be determined using a trained classifier, such as, for example, a CNN. FIG. 19 illustrates an example pipeline 2200 for classifying elevator arrival using a CNN 2308, according to some embodiments. The classification can be performed by any of the robotic devices and/or other compute devices described herein. The pipeline 2200 can include receiving an input audio 2302 (e.g., raw sound data or files). The pipeline 2200 can include pre-processing 2304 the input audio 2302, including, for example, converting the input audio 2302 into a MEL-scaled spectrogram 2306 or other format.

The MEL-scaled spectrogram 2306 can input into a CNN (e.g., linear classifier model), which can output a prediction of elevator arrival. For example, the output prediction can be a binary output, e.g., indicating that an elevator is arriving or is not arriving. Alternatively, the output prediction can be a multi-classification output, e.g., indicating that an elevator going up is arriving, that an elevator going down is arriving, or that no elevator is arriving. The CNN 2308 can be a pre-trained CNN, which may have been trained and/or validated using labeled audio data, e.g., audio data indicative of elevator arriving and/or elevator going up or down, and labeled accordingly. In some embodiments, the CNN can be trained on data being captured by a deployed robotic device, e.g., based on comparing captured audio data with elevator API information. In some instances, weights for the CNN 2308 can be initialized using a Kaiming normal initialization strategy. In some cases, each convolutional layer in the CNN 2308 can be followed by batch normalization. In some cases, the CNN 2308 can be trained using cross entropy loss.

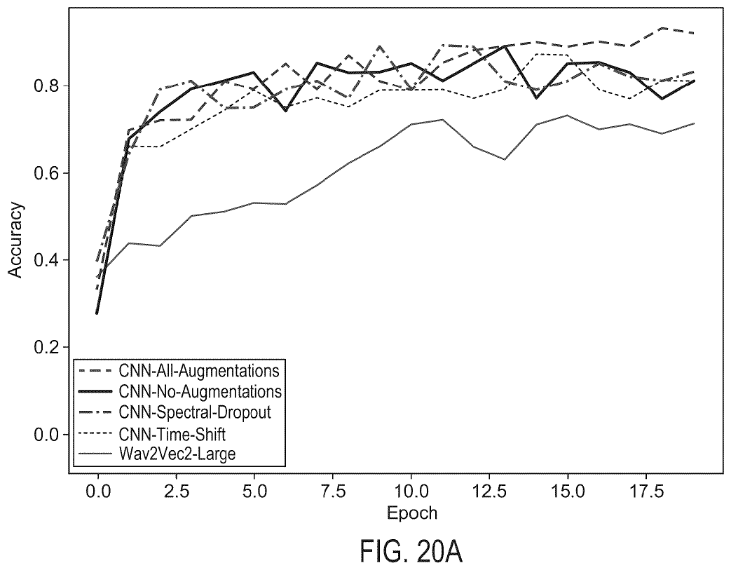

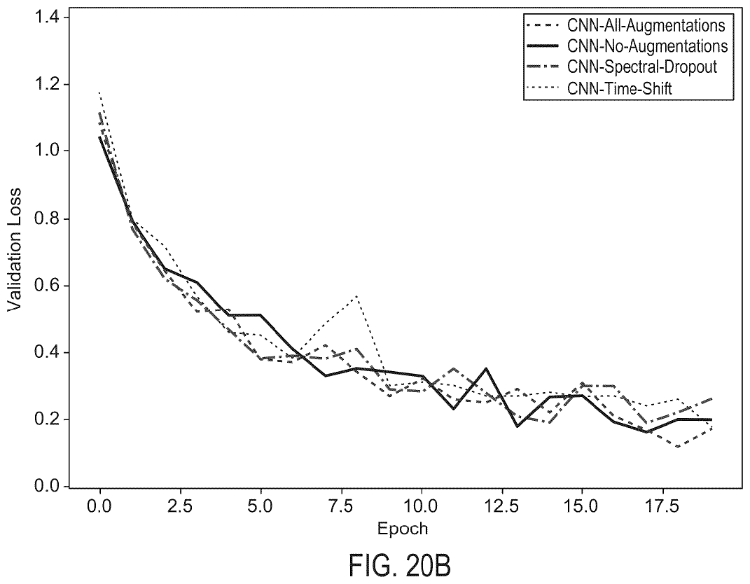

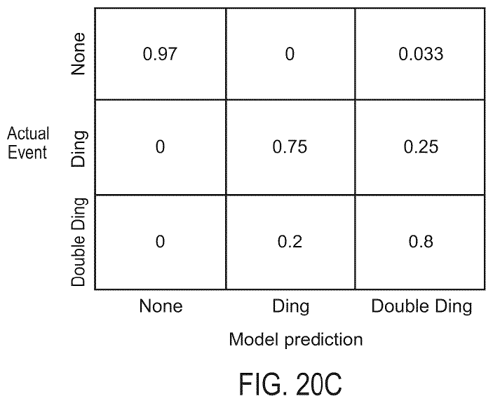

Various CNNs were trained using a training dataset of labeled audio data associated with elevator sounds. The results of the CNNs were compared to those of an existing audio recognition model (Wav2Vec2). FIGS. 20A-20C illustrate model accuracy comparison and validation loss comparison from audio signal classification using the CNNs and the prior audio model (Wav2Vec2). In training the CNNs, various augmentations were implemented to generate a larger training dataset. The augmentation included augmentation via timeshifting and/or Mel Spectrogram masking. Timeshift augmentation can include shifting an audio input left-to-right by a random amount. Mel Spectrogram masking can include using a sampled masked spectrogram input. The Mel Spectrogram masking can include a frequency mask and/or a time mask. The frequency mask can include randomly masking out a range of consecutive frequencies by adding horizontal bars on the spectrogram. The time mask includes randomly blocking out ranges of time from the spectrogram by using vertical bars.

FIG. 20A depicts a model accuracy comparison plot. Model accuracy was calculated on a separate validation dataset that was not used in the training process. Accuracy was calculated by dividing the number of correct predictions by the total number of predictions. FIG. 20B depicts a validation loss comparison plot. The validation loss was also calculated on a withheld validation dataset. The validation loss was based on cross-entropy. As shown in FIGS. 20A-20B, the CNN trained with all the data augmentations had the greatest accuracy and least validation loss. FIG. 20C depicts a confusion matrix for the CNN trained with all the data augmentation, showing low percentages of inaccurate predictions. The matrix compares the actual target values with those predicted by the machine learning model. In FIG. 20C, none indicates that no elevator is arriving, ding indicates that an elevator going up is arriving, and double ding indicates that an elevator going down is arriving.

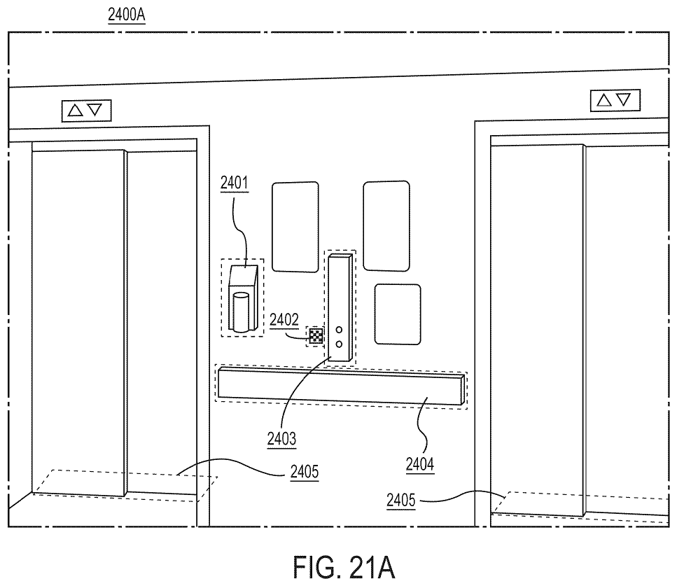

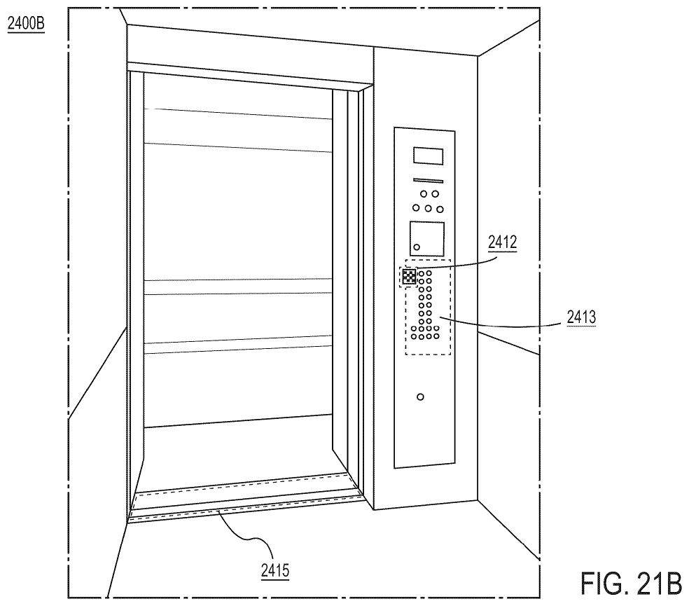

FIGS. 21A-21B illustrate an example screenshot for floor button management by a robotic device, according to some embodiments. As shown in FIG. 21A, screenshot 2400A depicts a view of a robotic device facing elevator doors in an elevator lobby. From sensors of the robotic device, the robotic device can perceive objects such as collision object 2401, collision object 2404, fiducial 2402, call button panel 2403, 2D door bounding boxes 2405, and/or the like. The collision objects 2401/2404 can be perceived by the robotic device as obstacles. The fiducial 2402 can be a reference point for the robotic device during elevator navigation. The call button panel 2403 can represent an object associated with a waypoint for the robotic device to press a button to call for an elevator. The 2D door bounding boxes 2405 can depict areas in the elevator lobby/shaft for elevators to arrive at.

As shown in FIG. 21B, screenshot 2400B can depict a view of the robotic device from inside the elevator. The view can include 2d bounding box 2415, fiducial 2412, floor button panel 2413, and/or the like. The floor button panel 2413 can represent a space in the view in which the robotic device can interact with to press a desired button. In some cases, the floor button panel 2413 can be a fiducial 2412. The view can also depict 2D door bounding box 2415 which can be a space that the robotic device can interpret as an elevator doorway.

### Elevator Pose Selection

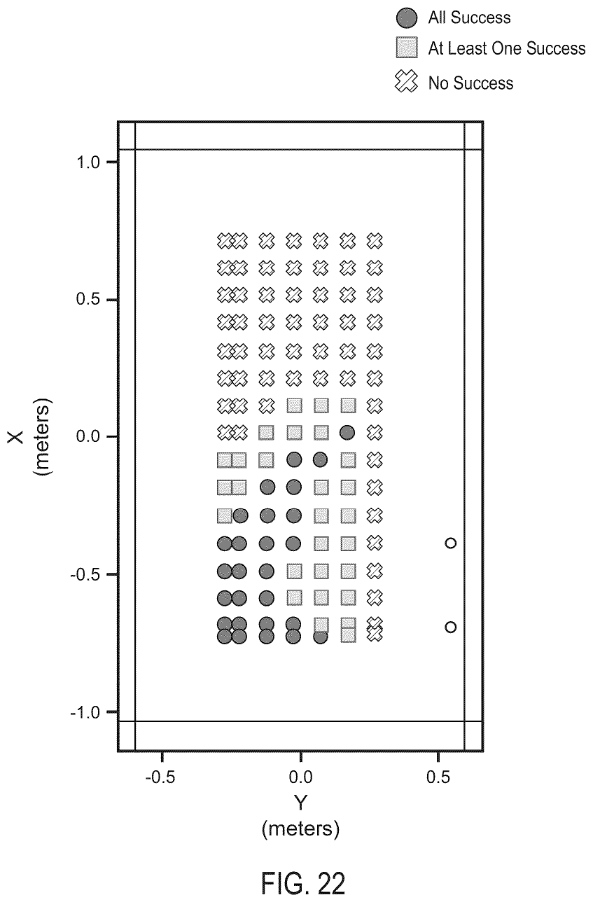

The robotic device may utilize an elevator tuck pose (e.g., a pose or configuration of the manipulating element of the robotic device) when operating an elevator car, e.g., as discussed with respect to FIG. 11. When operating an elevator car, the robotic device may face the following constraints: (1) the amount of time the robotic device has to press the elevator button is limited, and (2) the space the robotic device can use to move its arm and base to a desired position is restricted due to elevator size, layout, and/or occupancy. Both of these factors can impact selection of an elevator tuck pose. The elevator tuck pose is a starting position of a trajectory of the arm of the robotic device for pressing an elevator button. The elevator tuck pose is designed to position the arm of the robotic device closer to the body to reduce disturbances to nearby people. Given that each elevator car may have a different configuration, different tuck poses should be tailored to different elevator car configurations to improve success of the robotic device in pressing elevator buttons. Implementing different elevator tuck poses may also increase the possible number of usable base positions because certain elevator tuck poses may enable safe maneuvering of the robotic device to otherwise restricted base positions. Different elevator tuck poses may have different probability of success for pressing an elevator button depending on the base location of the robotic device, the elevator size and layout, and the location of the button panel in the elevator. A mechanism for choosing an elevator tuck pose from a variety of elevator tuck poses which maximizes or increases the success rate of pushing elevator buttons is described below with respect to FIGS. 22-33.

FIG. 22 is an example of a reachability map depicting the probability or likelihood of a robotic device successfully pressing an elevator button as a grid of base positions inside an elevator car. The floor of the elevator is represented by an X-Y plane, and points on this plane represent the position of the robot base within the elevator. In an embodiment, the x-axis (i.e., the axis labeled “X”) of the reachability map corresponds to coordinates along the width of the elevator car in meters, with the center of the width of the elevator car located at coordinate 0.0. The y-axis (i.e., the axis labeled “Y”) of the reachability map corresponds to coordinates along the depth of the elevator car in meters, with the center of the depth of the elevator car located at coordinate 0.0. The reachability map may be generated by determining the number of successful button presses across multiple trials at a given base position in the elevator car. The reachability map indicates from which base positions in the elevator car the robotic device would have or is likely to have no successful button pushes (i.e., “No Success”), at least one successful button push (i.e., “At Least One Success”), or a successful button push every trial (i.e., “All Success”). Base positions that result in no successful button pushes are marked with a “X”, base positions that result in at least one successful button push out of all the trials are marked with a square, and the base positions that result in the robotic device successfully pushing the button in every trial are marked in with a circle. While the “X”, square, and circle are used to denote the likelihood or level of success of a given position, it can be appreciated that a robotic device (such as any of the robotic devices described herein) can use other information to denote or classify the level of success associated with a plurality of given positions within the elevator. In some embodiments, a reachability map for each elevator car is generated offline such that the robotic device may quickly load an existing reachability map to navigate to a base position that yields a high probability of success for a given elevator car and/or elevator bay.

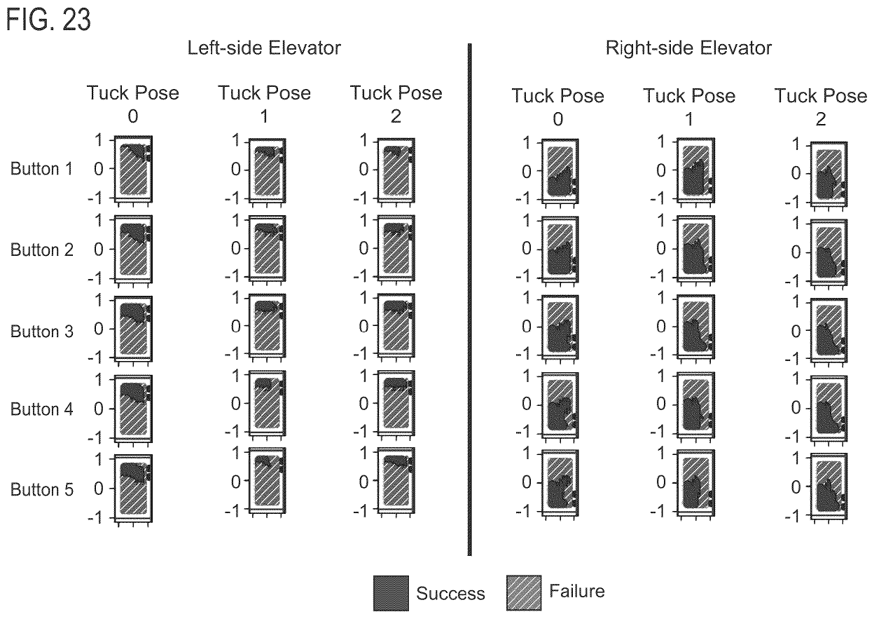

FIG. 23 depicts a set of reachability maps corresponding to each elevator button and elevator tuck pose for elevator cars with different layouts. The results of a reachability map may depend on whether the button panel is located on the left side of the elevator (i.e., “Left-side Elevator) or on the right side of the elevator (i.e., “Right-side Elevator”). The results of the reachability map may also depend on which button on the button panel the robotic device intends to push as well as the elevator tuck pose in which the robotic device begins. As shown, a reachability map is generated for each elevator button (Button 1, Button 2, Button 3, Button 4, Button 5) given each elevator tuck pose (Tuck Pose 0, Tuck Pose 1, Tuck Pose 2) for a left-side elevator and a right-side elevator. In some embodiments, the set of reachability maps may be used in an algorithm employed by the robotic device to inform the robotic device which elevator tuck pose(s) and/or base position(s) may lead to success in pushing a given elevator button. As shown, the reachability maps corresponding to the left-side elevator result in a lower success rate than the reachability maps corresponding to the right-side elevator, which signifies that the robotic device may need to choose from a smaller subset of base positions when entering a left-side elevator to successfully press any one of the elevator buttons.

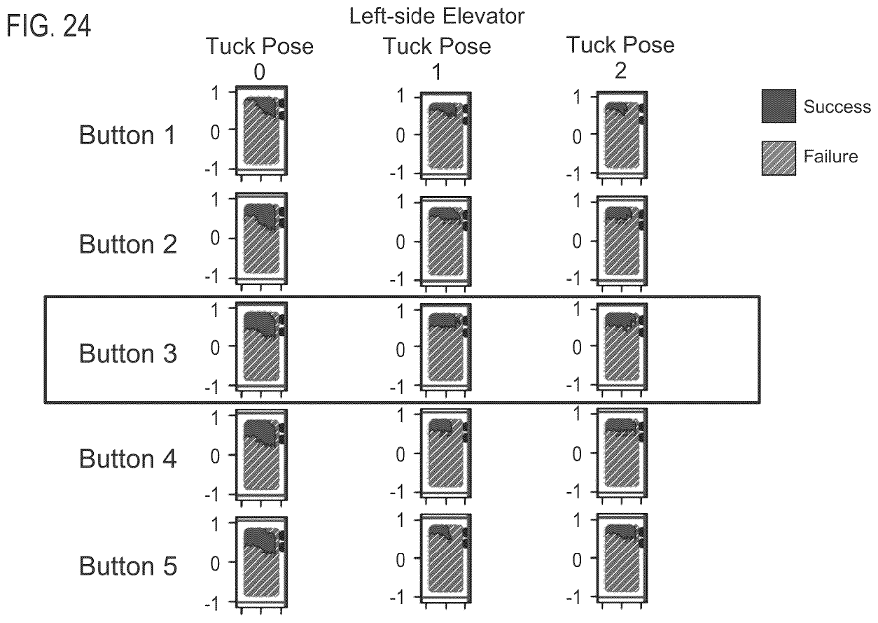

FIG. 24 denotes the subset of reachability maps that the robotic device can use to choose an elevator tuck pose that most likely enables the robotic device to successfully press a specific button in the elevator car. As shown in FIG. 24, the desired button to be pressed is “Button 3”. In some embodiments, the robotic device may compare the reachability maps of the three elevator tuck poses corresponding to “Button 3” and select the elevator tuck pose to use based on the total number of “Success” coordinates (e.g., the reachability map with the largest solid shaded area). For example, in some embodiments, the robotic device may select “elevator tuck pose 0” because the reachability map corresponding to this elevator tuck pose has the largest number of “Success” coordinates. In some embodiments, the robotic device may select the elevator tuck pose to use based on the largest number of connected “Success” coordinates (e.g., the reachability map with the largest contiguous “Success” or solid shaded area). In some embodiments, a “Success” coordinate may be considered connected if the “Success” coordinate has at least one neighboring “Success” coordinate. In some embodiments, a “Success” coordinate may be considered connected if the “Success” coordinate has neighboring “Success” coordinates in all cardinal directions (i.e., above, below, left, and right). In some embodiments, the robotic device may select “elevator tuck pose 0” because the reachability map corresponding to this elevator tuck pose has the largest number of connected “Success” coordinates.

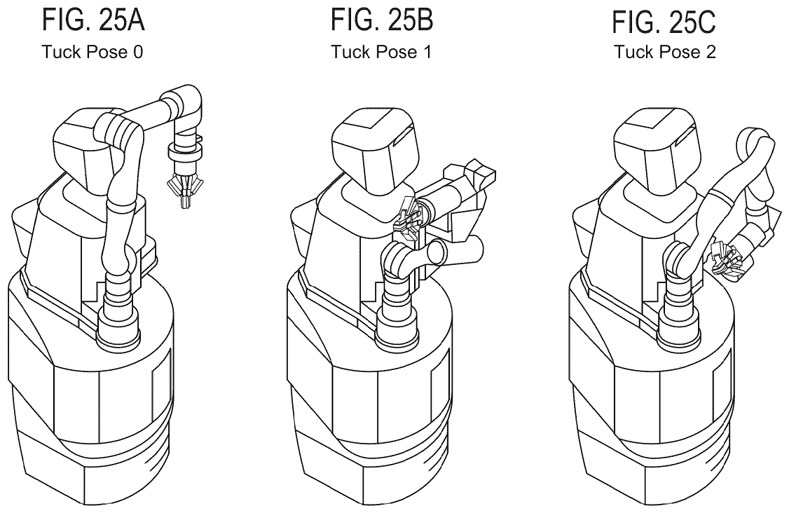

FIGS. 25A-25C depict a robotic device in three example elevator tuck poses. As shown in FIG. 25A, the robotic device is positioned in “Tuck Pose 0”. As shown in FIG. 25B, the robotic device is positioned in “Tuck Pose 1”. As shown in FIG. 25C, the robotic device is positioned in “Tuck Pose 2”. Each of the elevator tuck poses may be configured to position the arm of the robotic device to occupy the least amount of space. In some embodiments, the elevator tuck poses may be configured to allow the robotic device to easily maneuver the arm to press an elevator button.

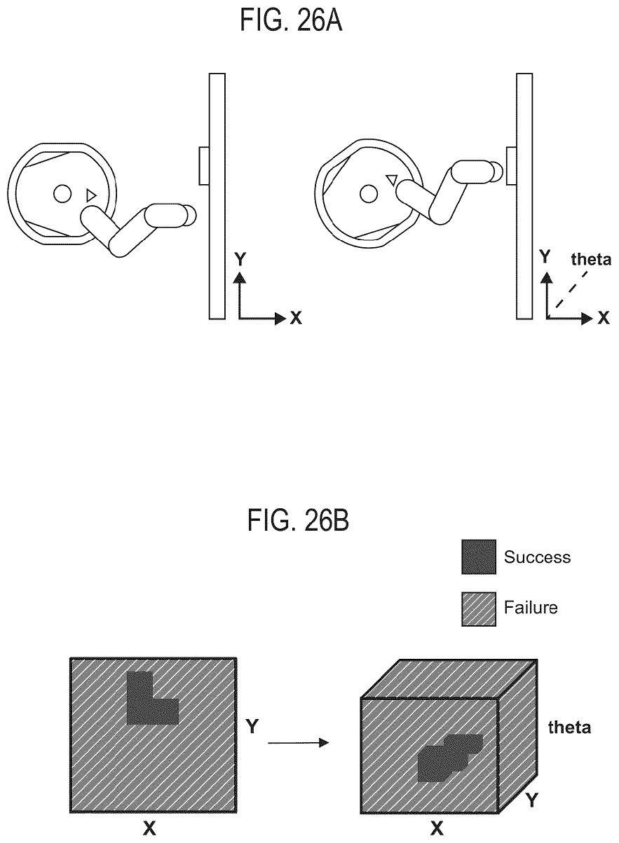

FIG. 26A depicts a top view of a robotic device pressing an elevator button with a base of the robotic device positioned at two example orientations. Each base position can have multiple orientations, and thus the robot's location within the elevator may be represented in 3 dimensions. In some embodiments, the reachability map may be generated by determining the number of successful button presses across multiple trials at a given base position (e.g., base location and orientation) in the elevator car. As shown in the left panel of FIG. 26A, the base of the robotic device is arranged such that a vector or axis extending from a front point of the base (shown as a white arrow) creates a 0-degree angle with the x-axis (i.e., the depth of the elevator car). As shown in the right panel of FIG. 26A, the base of the robotic device is arranged such that the vector or axis extending from the front point of the base (shown as a white arrow) creates an angle theta with the x-axis. In some embodiments, the angle theta that the base of the robotic device can be oriented is in a range of about −90 to about 90 degrees with respect to the x-axis. In some embodiments, the angle theta that the base of the robotic device can be oriented is in a range of about −80 to about 80 degrees, in a range of about −75 to about 75 degrees, in a range of about −60 to about 60 degrees, in a range of about −45 to about 45 degrees with respect to the x-axis. In some embodiments, the range of possible base angles theta at which the robotic device can use is constrained by whether the orientation of the robotic device is socially acceptable to not disturb surrounding people. For example, the base angles theta that result in the front of the robotic device facing away from the elevator button panel may not be considered because such orientation may appear socially abnormal to others in the elevator.

In some embodiments, the probability of successfully pressing each elevator button can be calculated for each angle theta of the base at each base location. FIG. 26B shows the transformation of an example 2-dimensional reachability map to an example 3-dimensional reachability map. As shown, the 3-dimensional reachability map has a first dimension (labeled “X”) corresponding to the depth of the elevator car, a second dimension (labeled “Y”) corresponding to the width of the elevator car, and a third dimension corresponding to the angle theta. This reachability map indicates the probability of the robotic device successfully pushing an elevator button at a given base position and angle theta. Certain aspects of the reachability maps of FIG. 26B may be substantially similar to the reachability map of FIGS. 22-24, and therefore certain aspects of the reachability maps of FIG. 26B are not described herein with respect to FIG. 26. In some embodiments, the robotic device may compare 3-dimensional reachability maps for each elevator button and each elevator tuck pose and select the elevator tuck pose to use based on the total number of “Success” coordinates (e.g., the reachability map with the largest solid shaded volume). In some embodiments, the robotic device may select the elevator tuck pose to use based on the largest number of connected “Success” coordinates (e.g., the reachability map with the largest contiguous solid shaded volume).

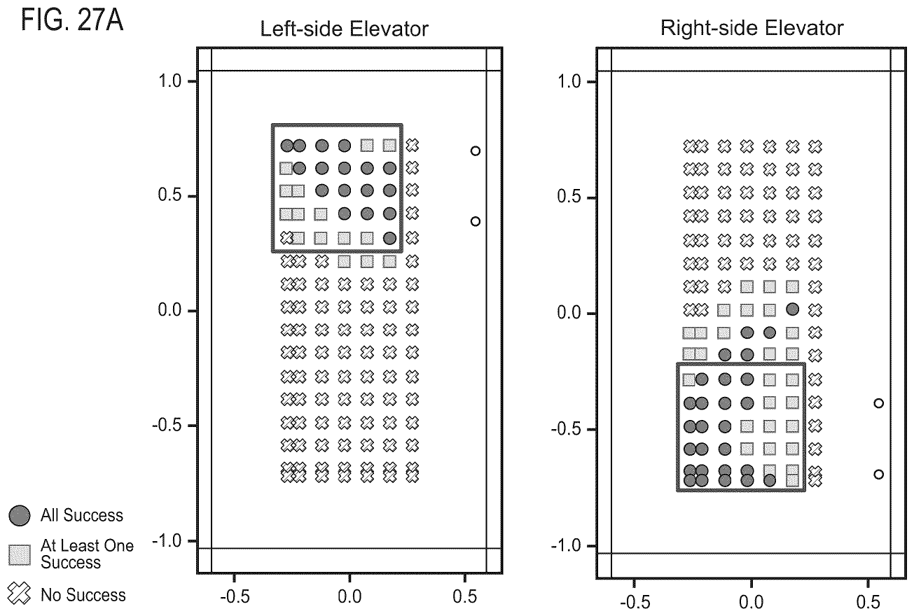

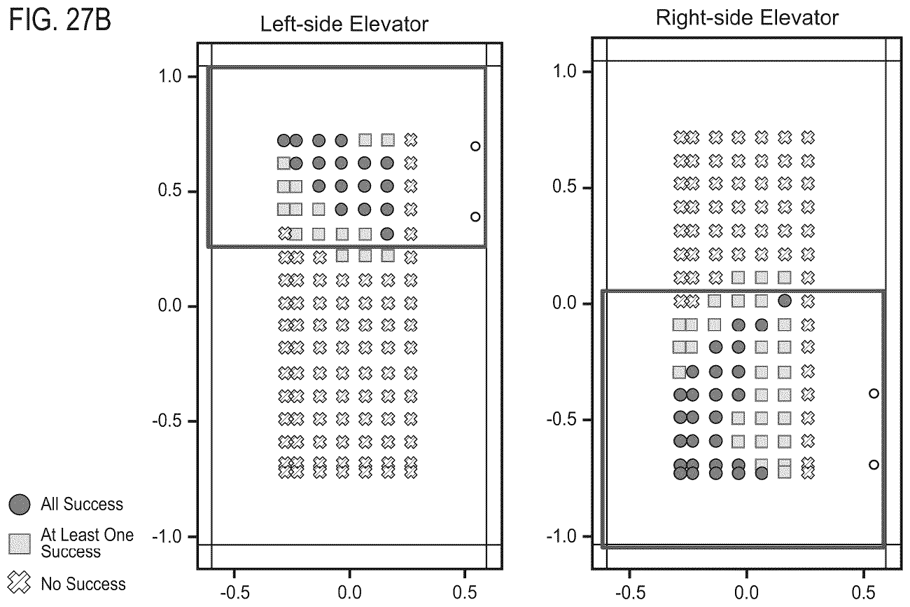

FIGS. 27A-27B show reachability maps depicting coordinates at which the reachability map can be cropped to reduce a computational load for the robotic device. When operating an elevator car, the robotic device should be capable of quickly assessing optimal elevator tuck poses and base positioning so as to not miss the elevator car or cause delay for surrounding people. Therefore, the algorithm used by the robotic device may prioritize reducing computation time. As shown in FIG. 27A, reachability maps of a left-side elevator and right-side elevator are cropped according to successful base positions. In order to reduce computational load of the robotic device and therefore increase the efficiency at which the robotic device operates the elevator car, the reachability map may be cropped such that the robotic device only considers a subset of coordinates in a region of interest (ROI) when assessing optimal base position and elevator tuck pose. In some embodiments, the reachability map may be cropped such that only coordinates closest to the elevator panel are within the ROI. In some embodiments, the reachability map may be cropped such that only coordinates that are “Success” (yield 100% success rate) and/or “At Least one Success” (yield at least one successful trial) are within the ROI. In some embodiments, the reachability map may be cropped such that base positions that are “No Success” (yield no success) are not considered by the robotic device. Although shown as a square, the ROI may be any shape that outlines a subset of coordinates to be analyzed. Implementing ROI's that only consider successful base positions can reduce unnecessary calculations performed by the robotic device, therefore improving overall efficiency of the algorithm used by the robotic device to select elevator tuck pose and base position.

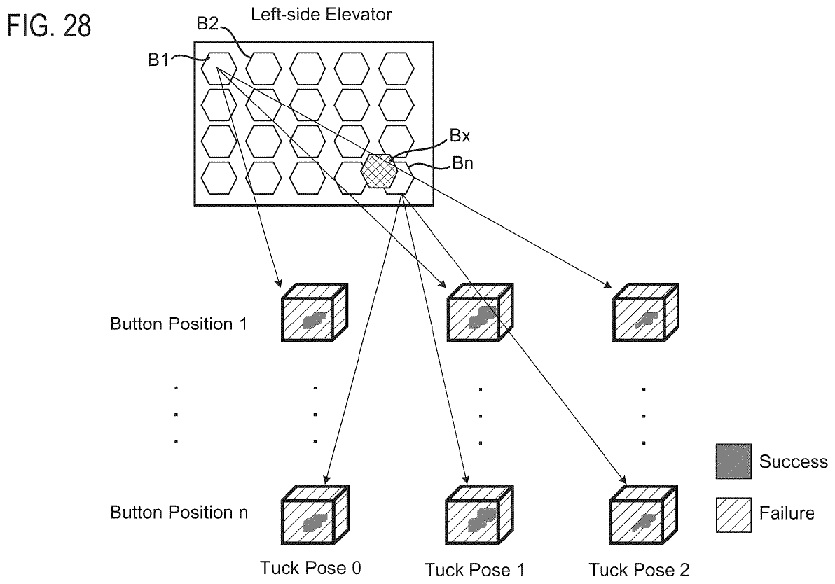

As shown in FIG. 27B, generic reachability maps of a left-side elevator car and a right-side elevator car are cropped according to a footprint of a target elevator car. Elevator cars can vary greatly in terms of dimension, footprint, and location of the button panel; therefore, generating reachability maps for each specific elevator can be computationally exhausting and time-consuming. Computational load of the robotic device may be reduced and therefore the efficiency at which the robotic device operates the elevator car may be increased, by generating a generic reachability map(s) and cropping the generic reachability map(s) according to the target elevator car's specific footprint. In some embodiments, the generic reachability map(s) may be generated by generating a reachability map that is expected to cover an area larger than all or most elevators. The generic reachability map(s) may be cropped such that the robotic device only considers a subset of coordinates that fall within the target elevator car's footprint when assessing optimal base position and elevator tuck pose. In some embodiments, some base positions that may lead to successful pressing of an elevator button in the uncropped reachability map may no longer be considered in the cropped reachability map because these base positions may reside too close to the edge of the footprint of the elevator car. While FIG. 27A-27B shows reachability maps generated for a generic elevator floor plan, reachability maps may additionally and/or alternatively be generated for a generic elevator interface button, as described in further detail with respect to FIG. 28. Reachability maps may be generated based on a set of base positions (e.g., location and orientation of the base), button positions (e.g., a location and orientation of a button), and tuck poses. In some embodiments, reachability maps for a plurality of button positions may be calculated based on a set of base positions and tuck poses. In some embodiments, reachability maps for a plurality of base positions may be calculated based on a set of button positions and tuck poses. For example, a set of button positions and a set of tuck poses (e.g., tuck pose 0, tuck pose 1, tuck pose 2 shown in FIGS. 25A-25C) may be predefined, and reachability maps across a plurality of base positions may be generated for each button position and tuck pose.

Reachability maps for a generic elevator button interface may be generated to reduce an amount of time for the robotic device to operate a given elevator. The generic elevator button interface may be a commonly used elevator interface and/or be a theoretical elevator button interface. When the robotic device interacts with a specific elevator button interface in the real world, a reachability map for a target button position on the specific elevator button interface may be interpolated from the reachability maps generated for the generic elevator button interface. FIG. 28 depicts an example of determination of reachability maps for a target button position Bx that is different than a set of button positions B1, B2, . . . Bn of a generic left-side elevator button interface. As shown, the generic left-side elevator button interface has 20 button positions, illustrated by the grid of hexagons B1, B2, . . . Bn. While illustrated as using 20 button positions, the generic elevator button interface may include any suitable number of button positions or a plurality of predefined positions. A reachability map may be generated for each button position B1, B2,. Bn and for each tuck pose (e.g., tuck pose 0, tuck pose 1, and tuck pose 2). Each reachability map includes reachability information for a plurality of base positions (e.g., base location and orientation) in the elevator car.

A reachability map for the target button position Bx can be calculated based on the reachability maps of neighboring button positions in the generic left-side elevator button interface (e.g., button positions within a predefined distance or threshold of the target button, or button positions that overlap by a certain threshold with the target button). For example, in some embodiments, the reachability map corresponding to the target button position Bx may be determined based on an in-fill algorithm. The in-fill algorithm may include any suitable interpolation method such as, for example, an average, K nearest neighbors, a natural neighbor, linear interpolation, polynomial interpolation, or any other suitable method. Once the updated reachability map is generated, the tuck pose and the base position that yield the highest performance (e.g., a largest number of successes) may be chosen for the target button position Bx.

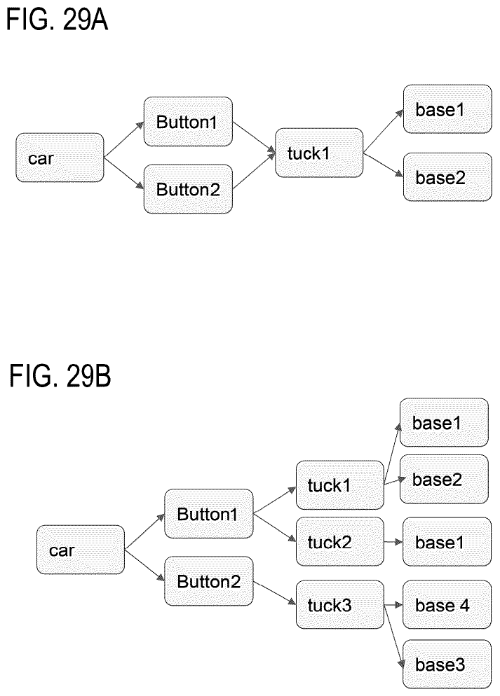

FIG. 29A-B are flow diagrams illustrating a decision tree for determining a tuck pose and base position for elevator operation. As shown in FIG. 29A, for a given elevator car (“car”) there may be two target buttons (“Button1” and “Button2”). For each button, the robotic device generates and evaluates reachability maps and determines that elevator tuck pose 1 (“tuck1”) is optimal for both target buttons. After determining an elevator tuck pose, the robotic device determines that given the reachability map corresponding to button 1 and elevator tuck pose 1, base position 1 (“base1”) and/or base position 2 (“base2”) are optimal locations for the robotic device to use. In addition, given the reachability map corresponding to button 2 and elevator tuck pose 1, base position 1 and/or base position 2 are optimal locations for the robotic device to use.

As shown in FIG. 29B, for a given elevator car (“car”) there may be two target buttons (“Button1” and “Button2”). For each button, the robotic device generates and evaluates reachability maps and determines that for button 1, elevator tuck pose 1 (“tuck1”) and elevator tuck pose 2 (“tuck2”) are optimal elevator tuck poses. For button 2, elevator tuck pose 3 (“tuck3”) is the optimal elevator tuck pose. Given the reachability map corresponding to button 1 and elevator tuck pose 1, the robotic device determines that base position 1 (“base1”) and base position 2 (“base2”) are the optimal locations for the robotic device to use. Given the reachability map corresponding to button 1 and elevator tuck pose 2, base position 1 is the optimal location for the robotic device to use. Give the reachability map for button 2 and elevator tuck pose 3, base position 3 (“base3”) and base position 4 (“base4”) are the optimal locations for the robotic device to use.

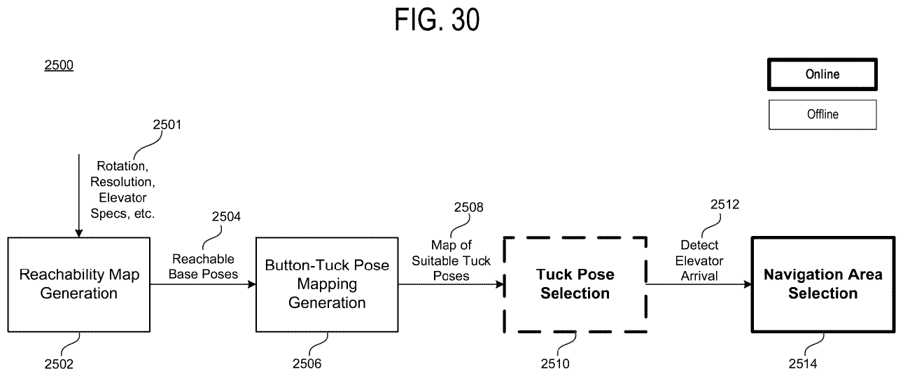

FIG. 30 is a flow diagram illustrating a method 2500 for determining an elevator tuck pose and base position, according to an embodiment. As shown, certain steps of the method for determining elevator tuck pose and base position may be performed offline by the robotic device, while certain steps of the method may be performed online (shown in bold) by the robotic device. In some embodiments, initial inputs 2501 for the method include a rotation range (i.e., a range of base orientations) of the robotic device, the target elevator car specifications (e.g., dimensions, location of button panel, etc.), the desired resolution of the reachability map, etc. The initial inputs 2501 may be used to generate a reachability map, at 2502. After generation of one or more reachability maps, the robotic device discerns the reachable base positions, at 2504, and this information is fed into a button-tuck pose mapping step, at 2506. In some embodiments, the reachability map may be cropped such that only the reachable base positions are considered. At 2506, button-tuck pose mapping generation is performed, in which the robotic device maps elevator tuck pose options that may yield a high success rate to each of the elevator buttons. For example, in some embodiments, for each elevator button, the robotic device may rank the elevator tuck poses based on the largest number of solid shaded coordinates in the reachability map(s) (or the cropped reachability map) generated at 2502. In some embodiments, the robotic device may select a subset of suitable elevator tuck poses based on rankings. A map of suitable tuck poses for each button 2508 is output from 2506 and used as an input for a tuck pose selection step, at 2510. In some embodiments, 2506 and 2510 may occur simultaneously. For example, the tuck poses may be ranked and the selection of the tuck pose may be at least partially based on the rankings. For example, both the ranking and the selection of the tuck poses may be performed online in one step. In some embodiments, the tuck pose selection step 2510 may be optional. In some embodiments, the tuck pose may be optionally adjusted based on a surrounding environment. in some embodiments, the tuck pose selection step 2510 may be performed online by the robotic device, as the robotic device may consider obstacles monitored in real-time when selecting an elevator tuck pose. For example, elevator tuck pose 0 may be the most optimal tuck pose according to the button-tuck pose mapping; however, the robotic device may need to select elevator tuck pose 1 in order to fit into available space in the elevator car. After the elevator tuck pose is determined, the robotic device may detect the arrival of the elevator car 2512 and uses this information to perform a navigation area selection step, at 2514. The navigation area selection step 2514 may be performed online by the robotic device because the robotic device may need to consider obstacles monitored in real-time when selecting a base position. For example, a person may be standing in the most optimal base position, and therefore the robotic device must adapt the navigation area selection 2514 to account for this obstacle. After the robotic device selects a navigation area, the robotic device may navigate to the selected position while in the elevator tuck pose and then may proceed to press the target button.

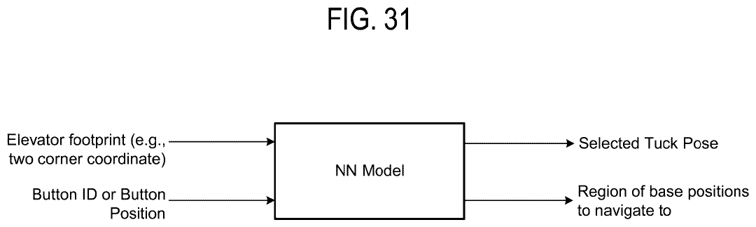

FIG. 31 is a flow diagram illustrating a method for determining a tuck pose and base position using a neural network model, according to an embodiment. The method can be performed by any of the robotic devices described herein. FIG. 31 can represent an end-to-end learning approach, whereby certain inputs (e.g., sensor data, elevator information) are provided to achieve control of the robotic device, without requiring intermediate steps of using reachability maps, obstacle detection, etc. For example, as depicted in FIG. 31, a neural network model may be used for elevator tuck pose and base position selection. In an example method, initial inputs into the model include an elevator footprint (e.g., two corner coordinate) and a button ID and/or button position. The neural network model may then output a selected elevator tuck pose and a region of base positions to which the robotic device may navigate given the initial inputs. The neural network can be configured with specific network architecture that learns multiple steps, processes, or modules needed to select an elevator tuck pose and a base pose, and can be trained using previously recorded data from robotic devices in operation. While a neural network is described with reference to FIG. 31, it can be appreciated that other types of machine learning algorithms can be used to determine a tuck pose and a base position, e.g., using end-to-end learning approaches.

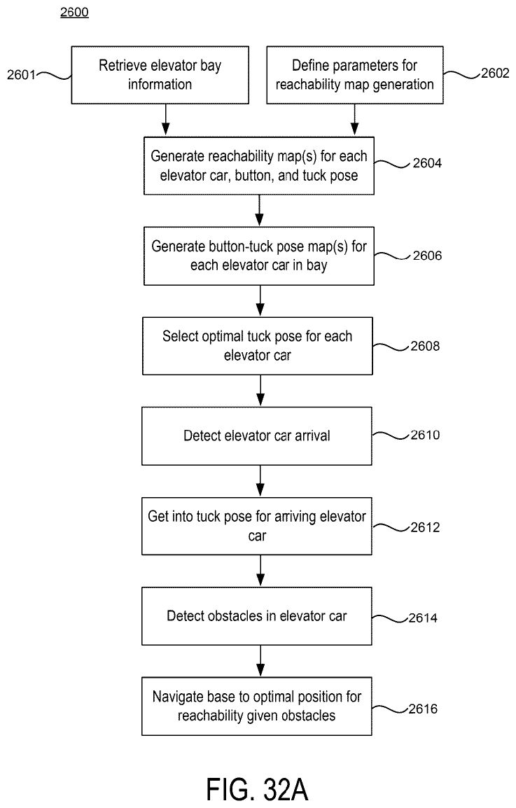

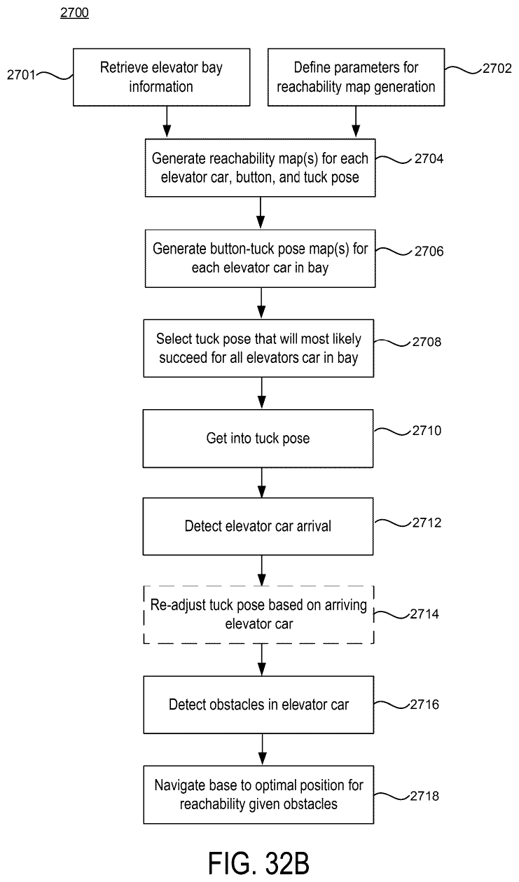

FIG. 32A is a flow diagram illustrating a method 2600 for using an elevator car by a robotic device, according to an embodiment. At 2601, the robotic device retrieves information about the elevator bay, and at 2602 the robotic device defines parameters (e.g., resolution of reachability map, the footprint of the elevator, the location of the button panel, the number of base orientations to consider, etc.) for generating reachability map(s). The robotic device generates reachability map(s) for each elevator car, button, and elevator tuck pose, at 2604. At 2606, the robotic device generates button-tuck pose map(s) for each elevator car in the bay. Certain aspects of the reachability map(s) and button-tuck pose map(s) may be substantially similar to the reachability map(s) described in reference to FIGS. 22-28 and the button-tuck pose map(s) described in reference to FIG. 30, and therefore certain aspects of the reachability map(s) and button-tuck pose map(s) are not described herein with respect to FIG. 31. In some embodiments, the robotic device may select the optimal elevator tuck pose for each elevator car in the elevator bay, at 2608. In some embodiments, the optimal elevator tuck pose for a given elevator car is selected based on the elevator tuck pose that yields the highest rate of success (i.e., the highest area of solid shaded coordinates on the reachability map) for that elevator car. At 2610, the robotic device detects the arrival (or upcoming arrival) of the elevator car. At 2612, the robotic device maneuvers into the selected elevator tuck pose for the elevator car that is arriving. The robotic device may then detect obstacles in the elevator car, at 2614. At 2616, the robotic device navigates the base to an optimal position for reachability given any obstacles the robotic device detected. In some embodiments, the robotic device may optionally update the base position at any time given the presence of new obstacles.

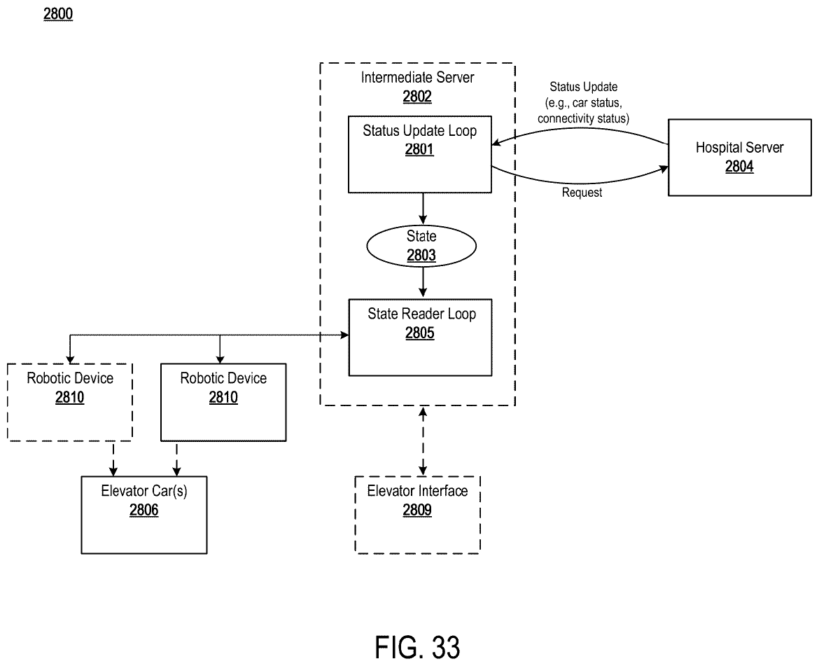

FIG. 32B is a flow diagram illustrating a method 2700 for using an elevator car by a robotic device, according to an embodiment. At 2701, the robotic device retrieves information about the elevator bay, and at 2702 the robotic device defines parameters (e.g., resolution of reachability map, the footprint of the elevator, the location of the button panel, the number of base orientations to consider, etc.) for generating reachability map(s). The robotic device generates reachability map(s) for each elevator car, button, and elevator tuck pose, at 2704. At 2706, the robotic device generates button-tuck pose map(s) for each elevator car in the bay. Certain aspects of the reachability map(s) and button-tuck pose map(s) may be substantially similar to the reachability map(s) described in reference to FIGS. 22-28 and the button-tuck pose map(s) described in reference to FIG. 30, and therefore certain aspects of the reachability map(s) and button-tuck pose map(s) are not described herein with respect to FIG. 33. In some embodiments, the robotic device may select the elevator tuck pose that is most likely to succeed for all elevator cars in a given bay, at 2708. Selection of one elevator tuck pose for all elevator cars in a bay may reduce computational load of the robotic device, and therefore improve efficiency of the robotic device. At 2710, the robotic device may maneuver into the selected elevator tuck pose. At 2710, the robotic device detects the arrival (or upcoming arrival) of the elevator car. Optionally, the robotic device may re-adjust the selected elevator tuck pose based on the arriving elevator car, at 2714. At 2716, the robotic device may then detect obstacles in the elevator car. In some embodiments, the robotic device may update the elevator tuck pose selection based on obstacles detected in the elevator car. At 2718, the robotic device navigates the base to an optimal position for reachability given any obstacles the robotic device detected. In some embodiments, the robotic device may optionally update the base position at any time given the presence of new obstacles.

### Elevator Request System

In order to enable multi-floor elevator travel of the robotic device in a hospital setting, it is important to have a robust and efficient elevator calling system. There are certain considerations when calling elevator cars in a hospital environment due to constraints of the hospital server and/or the hospital network. For example, the hospital server may be configured to receive only one external connection at a given time due to bandwidth constraints and/or security concerns. There may also be unpredictable internet connectivity, and connection to the hospital server may fail arbitrarily. In some cases, connection failures can only be resolved by restarting the system. Another possible constraint is the status of temporarily unavailable elevators may not be visible to the caller (e.g., the robotic device(s)).

FIG. 33 is a schematic block diagram of a system 2800 for operating elevator using an intermediate server 2802, according to an embodiment. As shown, the system 2800 includes an intermediate server 2802 configured to communicate with a hospital server 2804, one or more elevator cars 2806, and one or more robotic device(s)s 2810, and optionally an elevator interface 2809. The system 2800 may enable a robotic device(s) 2810 to accomplish the following tasks: (1) to call at least one available elevator car 2806 in an elevator bay (i.e., via an elevator Application Programming Interface (API)); (2) to call the elevator car 2806 to a desired floor inside an elevator car 2806 with poor or limited Wi-Fi connection; and/or (3) to receive live status updates for elevator cars 2806 at a predefined frequency (e.g., 1 Hz).

As shown, the intermediate server 2802 may be configured to request and/or receive data from the hospital server 2804. In some embodiments, the intermediate server 2802 may be any suitable server. In some embodiments, the intermediate server 2802 may be a cloud-hosted server. In some embodiments, the hospital server 2804 and the intermediate server 2802 may have a single half-duplex connection, meaning that the intermediate server 2802 cannot transmit and receive data simultaneously from the hospital server 2804. Therefore, the intermediate server 2802 may request a status update from the hospital server 2804, and the hospital server may subsequently send the status update. In some embodiments, the hospital server 2804 and intermediate server 2802 may use a Modbus protocol (e.g., Modbus batch polling) such that the hospital server 2804 may initiate the status update upon a request from the intermediate server 2802.

In some embodiments, the intermediate server 2802 may include a status update loop 2801 configured to periodically request a status update from the hospital server 2804. In some embodiments, the intermediate server 2802 may be configured to accumulate requests from a plurality of robotic devices 2810 and transmit the requests to the hospital server sequentially. Upon receiving the request, the hospital server 2804 may send the status update to the intermediate server 2802. In some embodiments, the status update can include an elevator car status for any or all elevator cars and/or a server connectivity status. In some embodiments, the status update loop 2801 may detect disconnection of the intermediate server 2802 and/or the robotic device(s) 2810 to the hospital server 2804. In some embodiments, the status update request can be used as a probe to actively detect communication failures in the system 2800. In some embodiments, if the server connectivity status indicates that a communication failure exists for a predefined period of time, the intermediate server 2802 may restart (e.g., automatically restart) to resolve the communication failure and/or reduce likelihood of a communication failure while a robotic device(s) 2810 calls for an elevator car 2806.

In some embodiments, upon receiving the status update from the hospital server 2804, the intermediate server 2802 may store the state 2803 of the elevator car(s). In some embodiments, the intermediate server 2802 may include a state reader loop 2805 configured to periodically read the state 2803 received from the hospital server 2804. The state reader loop 2805 may initiate reading of the state 2803 at a frequency of about 0.1 Hz to about 20 Hz, inclusive of all ranges and subranges therebetween. In some embodiments, the state reader loop 2805 may initiate reading of the state 2803 at a frequency of about 0.5 Hz to about 2 Hz, inclusive of all ranges and subranges therebetween. In some embodiments, the state reader loop 2805 may initiate reading of the state 2803 at a frequency of about 1 Hz (i.e., the loop may read the state 2803 every 1 second). In some embodiments, the state 2803 may be sent to the robotic device(s) 2810 automatically without a request from the robotic device 210. For example, the state 2803 may be sent to the robotic device(s) 2810 at a frequency between 0.1 Hz to about 20 Hz, inclusive of all ranges and subranges therebetween. Therefore, the robotic device(s) 2810 may have live connectivity status and elevator car status updates before and during calling of an elevator car 2806. In some embodiments, the state 2803 may be sent to the robotic device(s) 2810 upon request from the robotic device(s) 2810.

The elevator interface 2809 may include a user interface tool that stores the real-time position of the elevator car(s) 2806 based on the state 2803 stored in the intermediate server. In some embodiments, the elevator interface 2809 may visualize the position (e.g., the real-time position) of the elevator car(s) 2806 based on the state 2803 stored in the intermediate server 2802. In some embodiments, the real-time position of the elevator car(s) 2806 may be visualized for the user and not stored.. The elevator interface 2809 may be a program configured to be executed on a compute device external to the robotic devices 2810, the intermediate server 2802, and the hospital server 2804.

As shown, the robotic device(s) 2810 and/or the elevator interface 2809 may communicate bi-directionally with the intermediate server 2802 using a full-duplex interaction (e.g., via a Websocket protocol). In some embodiments, when the robotic device(s) 2810 approaches an elevator bay, the robotic device(s) 2810 may send a request to each elevator car 2806 in the elevator bay at which the robotic device(s) 2810 is located. In some embodiments, the robotic device 2810 may send a request for each elevator car 2806 sequentially, and the intermediate server may in turn sequentially transmit the request for each elevator car 2806 to the hospital server 2804. The hospital server 2804 may then send a signal to cause one or more available elevator cars 2806 to move to a floor on which the robotic device 2810 is located. In some embodiments, the robotic device(s) 2810 may continue to send requests to the intermediate server 2802, and therefore elevator car 2806, until the robotic device(s) 2810 boards and/or the elevator car 2806 times out.

In some embodiments, the elevator calling process (i.e., the algorithm for requesting elevators) may be outside of the main state machine of the robotic device 2810 (e.g., on an ROS node). For example, the robotic device 2810 may send a request to the elevator calling process, and the elevator calling process may evaluate connection to the intermediate server 2802 and may call one desired elevator as a live calling test or connectivity test. In some embodiments, when the elevator calling process calls the desired elevator, the elevator calling process may receive the state 2803 from the intermediate server 2802. If the elevator car 2806 status and/or connectivity is confirmed, the main state machine of the robotic device 2810 may perform elevator monitoring and boarding while the elevator calling process continues calling elevator cars 2806 until the robotic device 2810 successfully boards the elevator car 2806 and/or the elevator car times out. This system 2800 may enable the robotic device(s) 2810 to detect temporary and/or non-immediately recoverable connection failures to the hospital server 2804. The system 2800 may enable the robotic device(s) 2810 to quickly detect when elevators open as the robotic device(s) 2810 calls them. The robotic device(s) may start boarding as at least one elevator opens.

In some embodiments, the intermediate server 2802 may be optional, and the hospital server 2804. For example, the robotic device 2810 may receive car status information and/or connectivity status information and may request elevators from the hospital server 2804 without the intermediate server 2802. In some embodiments, hospital server 2804 may send and/or receive information directly to the robotic device 2810 and/or a compute device associated with the robotic device 2810.

### Floor Detection

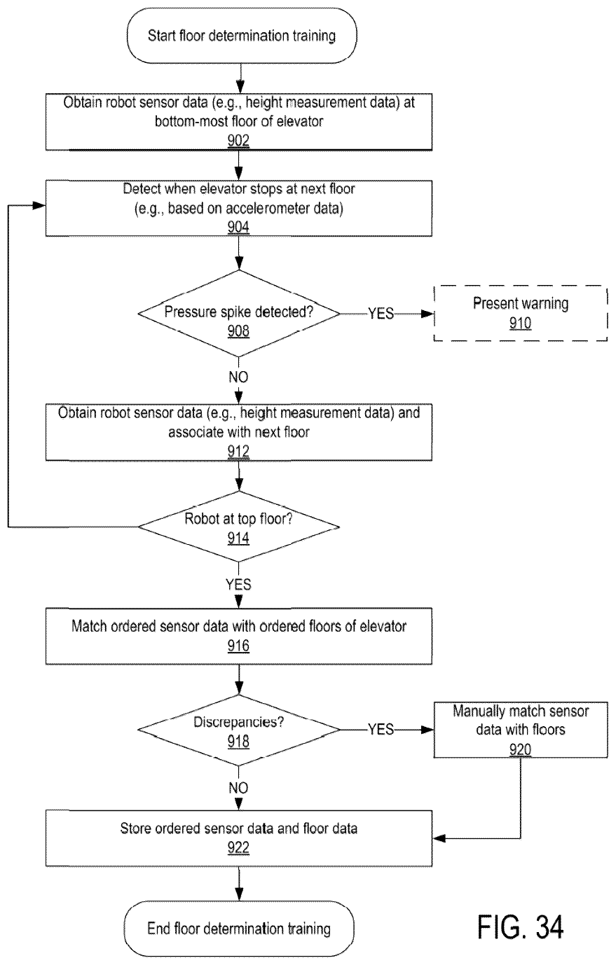

FIG. 34 is a flow chart of a method 900 for training a robotic device to perform floor detection, according to embodiments. The method 900 can be performed prior to having a robotic device autonomously navigate using elevators within a building.

As described above, a robotic device needs to be able to determine when it should exit an elevator. In some embodiments, the robotic device can rely on elevator APIs to determine when it has arrived at its target floor and to exit the elevator at that floor. In some embodiments, the robotic device may rely on inputs (e.g., from remote user) to exit an elevator. In such instances, however, a remote user needs to have a way of determining and/or validating the current location of the robotic relative to a floor. In some embodiments, the robotic device can rely on floor indicator data, e.g., as captured by the robotic device's imaging capture devices. In some embodiments, the robotic device may need to rely on sensor data such as, for example, barometer data, IMU data, acceleration data, etc. to determine and/or validate its current location relative to a floor. Method 900 provides an example of how sensor data of a robotic device can be calibrated for determining and/or validating the floor.

The average floor-ceiling height of a floor is about 9 feet or 2.74 meters. As such, the robotic device can be calibrated to have a relative height accuracy of less than half the height of a floor. At 902, the method 900 includes obtaining robot sensor data (e.g., barometer data, IMU data, altimeter data, etc.) at a first floor of a building or elevator.

The robotic device can ride an elevator within the building to another floor, and the robotic device can detect when the elevator has stopped at the new floor, e.g., based on velocity and/or accelerometer data, at 904. At 908, the robotic device can determine whether a pressure spike has occurred. A pressure spike can be indicative of the sensor data being noisy and/or unreliable. If a pressure spike has occurred (908: YES), then the robotic device can optionally present a warning, at 910. At 912, the robotic device can obtain sensor data at the new floor.

The robotic device can continue to cycle through the steps of detecting when it has arrived at a new floor, determining whether there is a pressure spike, and/or obtaining sensor data at the new floor until the robotic device is at a top floor (or final floor for training), at 914. During training, a user may be present with the robotic device in the elevator, and can indicate to the robotic device when it has reached a top floor. Alternatively or additionally, a remote user may indicate to the robotic device that it is at a top floor. In some embodiments, the robotic device may be aware of a total number of floors that a building may have, and can count to determine when it has reached a top floor and has collected sufficient sensor data for setting up its floor detection algorithm.

At 916, the robotic device can match the ordered sensor data with ordered floors of the building or elevator. In other words, the robotic device can associate sensor data captured at each detected floor with a respective floor of the building or elevator. At 918, the robotic device (or another compute device or user) can determine whether there are discrepancies between the ordered sensor data and the ordered floor data. If discrepancies exist (918: YES), the data can be manually adjusted to match the sensor data with the correct floors, at 920. If no discrepancies exist, then the ordered sensor data and floor data can be stored, at 922. This data can later be used by a robotic device to determine a floor that it (or the elevator is it riding) is near or at. While an example method 900 for training a robotic device to perform floor detection is depicted in FIG. 34, it can be appreciated that any number of floor detection training methods can be used.

It is to be noted that any one or more of the aspects and embodiments described herein can be conveniently implemented using one or more machines (e.g., one or more compute devices that are utilized as a user compute device for an electronic document, one or more server(s) devices, such as a document server, etc.) programmed according to the teachings of the present specification. Appropriate software coding can readily be prepared by skilled programmers based on the teachings of the present disclosure. Aspects and implementations discussed above employing software and/or software modules can also include appropriate hardware for assisting in the implementation of the machine executable instructions of the software and/or software module.

Such software can be a computer program product that employs a machine-readable storage medium. A machine-readable storage medium can be any medium that is capable of storing and/or encoding a sequence of instructions for execution by a machine (e.g., a compute device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software can also include information (e.g., data) carried as a data signal on a data carrier, such as a carrier wave. For example, machine-executable information can be included as a data-carrying signal embodied in a data carrier in which the signal encodes a sequence of instruction, or portion thereof, for execution by a machine (e.g., a compute device) and any related information (e.g., data structures and data) that causes the machine to perform any one of the methodologies and/or embodiments described herein.

Examples of a compute device include, but are not limited to, an electronic book reading device, a computer workstation, a terminal computer, a server(s) computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a compute device can include and/or be included in a kiosk.

All combinations of the foregoing concepts and additional concepts discussed herewithin (provided such concepts are not mutually inconsistent) are contemplated as being part of the subject matter disclosed herein. The terminology explicitly employed herein that also can appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments can be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments cannot have been presented for a specific portion of the innovations or that further undescribed alternate embodiments can be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments can be utilized and functional, logical, operational, organizational, structural and/or topological modifications can be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For example, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general-purpose processor, a central processing unit (CPU), a microprocessor, a digital signal processor (DSP), a controller, a microcontroller, a state machine and so forth. Under some circumstances, a “processor” can refer to an application specific integrated circuit (ASIC), a programmable logic device (PLD), a field programmable gate array (FPGA), etc. The term “processor” can refer to a combination of processing devices, e.g., a combination of a DSP and a microprocessor, multiple microprocessors, one or more microprocessors in conjunction with a DSP core or any other such configuration.

The term “memory” should be interpreted broadly to encompass any electronic component capable of storing electronic information. The term memory can refer to various types of processor-readable media such as random-access memory (RAM), read-only memory (ROM), non-volatile random-access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” can refer to one or more programs, routines, sub-routines, functions, procedures, etc. “Instructions” and “code” can comprise a single computer-readable statement or many computer-readable statements.

The term “modules” can be, for example, distinct but interrelated units from which a program may be built up or into which a complex activity may be analyzed. A module can also be an extension to a main program dedicated to a specific function. A module can also be code that is added in as a whole or is designed for easy reusability.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts can be embodied as one or more methods, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

In addition, the disclosure can include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein can be implemented in a manner that enables a great deal of flexibility and customization as described herein.

All definitions, as defined and used herein, should be understood to control over dictionary definitions, definitions in documents incorporated by reference, and/or ordinary meanings of the defined terms.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus, comprising:
a memory;
a processor operatively coupled to the memory, the processor configured to execute instructions stored in the memory to:
retrieve information of an elevator car, the information including a floorplan of the elevator car and a configuration of an elevator button interface in the elevator car;
determine, for each value of a first parameter from a plurality of parameters, a likelihood of successfully pressing a target button across a range of values of one or more second parameters from the plurality of parameters other than the first parameter by simulating, over a plurality of trials, pressing the target button at that value of the first parameter and across the range of values of the one or more second parameters, the plurality of parameters including a location of the target button, a position of a robotic device, and a pose of a manipulating element of the robotic device;
generate, for each value of the first parameter, a reachability map indicative of the likelihood of successfully pressing the target button across the range of values of the one or more second parameters based on outcomes of simulating the pressing over the plurality of trials; and
store the reachability map for each value of the first parameter in the memory.

2. The apparatus of claim 1, wherein the position of the robotic device includes a location and an orientation of a transport element of the robotic device.

3. The apparatus of claim 1, wherein the first parameter is the position of the robotic device, and the one or more second parameters include the location of the target button and the pose of the manipulating element,
the processor being configured to determine, for each value of the first parameter, the likelihood of successfully pressing the target button across the range of values of the one or more second parameters by:
simulating, for each of a plurality of predefined positions of the robotic device, pressing the target button across a range of predefined locations of the target button and a plurality of predefined poses of the manipulating element;
repeating, for the plurality of trials, the simulating for each of the plurality of predefined positions of the robotic device; and
determining, for each of the plurality of predefined positions of the robotic device, a percentage of the plurality of trials representing successes of pressing the target button.

4. The apparatus of claim 1, wherein the first parameter is the location of the target button, and the one or more second parameters include the position of the robotic device and the pose of the manipulating element,
the processor being configured to determine, for each value of the first parameter, the likelihood of successfully pressing the target button across the range of values of the one or more second parameters by:
simulating, for each of a plurality of predefined locations of the target button, pressing the target button across a range of predefined positions of the robotic device and a plurality of predefined poses of the manipulating element;
repeating, for the plurality of trials, the simulating for each of the plurality of predefined locations of the target button; and
determining, for each of the plurality of predefined locations of the target button, a percentage of the plurality of trials representing successes of pressing the target button.

5. The apparatus of claim 1, wherein the first parameter is the pose of the manipulating element, and the one or more second parameters include the location of the target button and the position of the robotic device,
the processor being configured to determine, for each value of the first parameter, the likelihood of successfully pressing the target button across the range of values of the one or more second parameters by:
simulating, for each of a plurality of predefined poses of the manipulating element, pressing the target button across a range of predefined locations of the target button and predefined positions of the robotic device;
repeating, for a plurality of trails, the simulating for each of a plurality of predefined poses of the manipulating element; and
determining, for each of a plurality of predefined poses of the manipulating element, a percentage of the plurality of trials representing successes of pressing the target button.

6. The apparatus of claim 1, wherein the processor is configured to generate, for each value of the first parameter, the reachability map by generating a plurality of reachability maps for a plurality of predefined poses of the manipulating element,
the processor further configured to:
determine which pose from the plurality of predefined poses of the manipulating element yielded a maximum number of positions of the robotic device that result in successfully pressing the target button; and
select that pose as the optimal pose for the elevator car.

7. The apparatus of claim 1, wherein the processor is configured to generate, for each value of the first parameter, the reachability map in an offline mode in which the robotic device is not executing one or more plans associated with navigation or manipulation.

8. An apparatus, comprising:
a manipulating element including a plurality of joints and segments, the manipulating element configured to be positioned in a plurality of poses for initiating a trajectory for pressing one or more target buttons;
a transport element configured to move along a surface;
one or more sensors; and
a processor operatively coupled to the manipulating element, the transport element, and the one or more sensors, the processor configured to:
determine a location of a target button in an elevator car;
determine which pose from the plurality of poses the manipulating element is positioned in;
select, using a reachability map associated with the pose, a position of the transport element likely to be successful at pressing the target button given the location of the target button; and
navigate, following a path, to the position of the transport element.

9. The apparatus of claim 8, wherein the processor is further configured to:
determine a set of positions of the transport element likely to be successful at pressing the target button,
the processor configured to select the position of the transport element from the set of positions and based on one or more environmental constraints.

10. The apparatus of claim 9, wherein the one or more environmental constraints include a location of an object or an obstacle.

11. The apparatus of claim 9, wherein the processor is further configured to:
cause the one or more sensors to scan for one or more obstacles along the path or in the elevator car.

12. The apparatus of claim 11, wherein the processor is further configured to:
in response to the one or more obstacles being detected in the path of the robotic device, select the position from the set of positions of the transport element that avoids collision with the one or more obstacles detected in the path of the robotic device.

13. The apparatus of claim 11, wherein the processor is further configured to:
in response to the one or more obstacles being detected in the path of the robotic device, modify the pose of the manipulating element to avoid collision with the one or more obstacles detected in the path of the robotic device; and
select, using a reachability map associated with the modified pose, a position of the transport element likely to be successful at pressing the target button given the location of the target button.

14. An apparatus, comprising:
a manipulating element including a plurality of joints and segments;
a transport element configured to move along a surface;
one or more sensors; and
a processor operatively coupled to the manipulating element, the transport element, and the one or more sensors, the processor configured to:
determine a position of a target button in an elevator car;
compare the position of the target button to a plurality of predefined positions of the target button;
in response to determining, based on the comparing, that the position of the target button does not match any one of the plurality of predefined positions, identify a set of predefined positions from the plurality of predefined positions that are closest to the position of the target button;
determine, based on a set of reachability maps indicative of a likelihood of pressing the target button at the set of predefined positions and across a range of predefined positions of the transport element, a reachability map indicative of a likelihood of pressing the target button at the position of the target button and across the range of predefined positions of the transport element.

15. The apparatus of claim 14, wherein the processor is further configured to:
generate, for each of the plurality of predefined positions of the target button, a reachability map indicative of a likelihood of pressing the target button at that predefined position and across the range of predefined positions of the transport element.

16. The apparatus of claim 14, wherein the manipulating element is configured to be positioned in a plurality of poses for initiating a trajectory of the manipulating element for pressing one or more target buttons, and the processor is further configured to:
generate, for each unique combination of a pose from the plurality of poses and a predefined position from the plurality of predefined positions, a reachability map indicative of a likelihood of pressing the target button at that unique combination of the pose and the predefined position and across the range of predefined positions of the transport element.

17. The apparatus of claim 16, wherein the processor is further configured to:
select a pose from the plurality of poses in which to position the manipulating element based on at least one of the reachability maps generated for the target button.

18. The apparatus of claim 14, wherein the processor is further configured to:
scan, using the one or more sensors, an environment surrounding the manipulating element and the transport element to determine whether there are one or more obstacles in the environment; and
in response to determining that there are one or more obstacles, determine a position to which to move the transport element to in the elevator car based on the reachability map determined for the position of the target button and a location of the one or more obstacles.

19. The apparatus of claim 14, wherein the processor is configured to identify the set of predefined positions by:
identifying one or more predefined positions from the plurality of predefined positions that overlap by a threshold amount with the position of target button.

20. The apparatus of claim 14, wherein the processor is configured to identify the set of predefined positions by:
identifying one or more predefined positions from the plurality of predefined positions that is within a predefined distance of the position of the target button.

21. A method, comprising:
calling, at a robotic device, at least one elevator car to arrive in an elevator lobby;
navigating, using a transport element of the robotic device, to a first location in the elevator lobby to wait for an arrival of the at least one elevator car;
determining, at the robotic device, that an elevator car is approaching the elevator lobby;
navigating, using the transport element, to a second location for boarding the elevator car that is approaching;
monitoring, using one or more sensors of the robotic device, a state of the elevator car to determine when to board the elevator car;
in response to determining to board the elevator car, boarding the elevator car by navigating from the second location to a third location within the elevator car; and
pressing a target button within the elevator car to select a destination floor.

22. The method of claim 21, wherein the calling the at least one elevator car includes sending a request to call the at least one elevator car to an intermediate device in communication with a server configured to control an operation of the at least one elevator car, such that the intermediate device, in response to receiving the request, sends a message to the server to cause the server to control the at least one elevator car to arrive in the elevator lobby.

23. The method of claim 21, wherein the calling the at least one elevator car includes sending a request to call multiple elevator cars to an intermediate device in communication with a server configured to control an operation of the multiple elevator cars, such that the intermediate device, in response to receiving the request, sends a message to the server to cause the server to control the multiple elevator cars to arrive in the elevator lobby,
the method further comprising:
in response to detecting, based on the monitoring, that an elevator car has arrived at the elevator lobby, sending a message to the intermediate device informing the intermediate device that an elevator car has arrive, such that the intermediate device sends a message to the server to cause the server to stop controlling additional elevator cars from arriving at the elevator lobby.

24. The method of claim 21, wherein the monitoring the state of the elevator car includes:
requesting information from an intermediate device regarding an arrival status of the at least one elevator car.

25. The method of claim 21, wherein the boarding the elevator car further includes:
monitoring, using the one or more sensors, an area near a doorway of the elevator car;
determining a path through the doorway of the elevator car based on the monitoring; and
moving the transport element of the robotic device through the doorway of the elevator car and into the elevator car along the path.

26. The method of claim 25, further comprising exiting the elevator car, the exiting the elevator car including:
monitoring, using the one or more sensors, the state of the elevator car while in the elevator car;
determining a path through the doorway of the elevator car based on the monitoring; and
moving the transport element of the robotic device through the doorway of the elevator car and out of the elevator car along the path.

27. The method of claim 26, wherein monitoring the state of the elevator car while in the elevator car includes:
monitoring, using one or more sensors of the robotic device, when the elevator is approaching the destination floor; and
monitoring, using one or more sensors of the robotic device, when the elevator door has opened at the destination floor.

28. The method of claim 21, further comprising:
determining that more than one elevator car is arriving at the elevator lobby; and
in response to determining that more than one elevator car is arriving at the elevator lobby, selecting one elevator car to board based on scanning an environment of the elevator lobby or the more than one elevator car.

29. The method of claim 21, wherein the monitoring the state of the elevator car to determine when the board the elevator car includes:
transmitting a plurality of light beams toward a bounding box indicating a location of a door of the elevator car;
determining (i) a number of light beams that extend a distance shorter than the bounding box, (ii) a number of light beams that extend a distance corresponding to the bounding box, and (iii) a number of light beams that extend a distance greater than the bounding box; and
determining that the door or the elevator car is open in response to determining that the number of light beams that extend beyond the distance corresponding to the bounding box is greater than a predetermined threshold.
